(19) United States
(12) Patent Application Publication
(10) Pub. No.: US 2024/0376765 A1
(43) Pub. Date: Nov. 14, 2024

(54) FENESTRATIONS EXHIBITING REDUCED THERMAL BOWING AND/OR LOCALIZED INCREASED STRENGTH

(71) Applicant: Andersen Corporation, Bayport, MN (US)

(72) Inventors: Trevor Dean Peterson, Stillwater, MN (US); Brett Thomas Peterson, Minneapolis, MN (US); Adam Richard Rietz, Lake St. Croix Beach, MN (US)

(21) Appl. No.: 18/592,131

(22) Filed: Feb. 29, 2024

Related U.S. Application Data
(60) Provisional application No. 63/449,435, filed on Mar. 2, 2023.

(51) Int. Cl. E06B 3/22; E06B 3/54

(52) U.S. Cl. CPC E06B 3/22; E06B 3/5454; E06B 3/549

(57) ABSTRACT

Embodiments herein relate to fenestrations and components of the same exhibiting reduced thermal bowing and/or enhanced localized strength. In an embodiment, a fenestration assembly is included with a sash including a bottom rail, a top rail, a first side stile, and a second side stile, along with an insulating glazing unit, wherein the insulating glazing unit is disposed between the top rail and the bottom rail and between the first side stile and the second side stile. At least one of the rails or stiles includes a first lineal extrusion formed with a first composition including at least 5 wt. % fibers and a first polymer resin. At least one of the rails or stiles includes a second lineal extrusion formed with a second composition including a second polymer resin. Other embodiments are also included herein.

### RELATED APPLICATIONS

This application claims the benefit of U.S. Provisional Application No. 63/449,435, filed Mar. 2, 2023, the content of which is herein incorporated by reference in its entirety.

### TECHNICAL FIELD

Embodiments herein relate to fenestrations and components of the same exhibiting reduced thermal bowing and optimized strength.

### BACKGROUND OF THE INVENTION

Fenestrations can include entry door systems, patio doors, windows and the like. Fenestrations generally include frame systems, sash systems, and/or other structural members for structural support. In many cases, depending on the location of the structure into which they are installed, the exterior portions of fenestrations are exposed to substantial air temperature swings from below zero temperatures to extremely high temperatures. In addition, energy from bright sun light may be absorbed to generate even higher extremes of temperatures. Unfortunately, some materials may exhibit a degree of thermal expansion and/or thermal deformation which can lead to thermal bowing of fenestration components which may negatively affect durability and/or aesthetics.

### SUMMARY OF THE INVENTION

Embodiments herein relate to fenestrations and components of the same exhibiting reduced thermal bowing and enhanced strength. In a first aspect, a fenestration assembly can be included having a sash. The sash can include a bottom rail, a top rail, a first side stile, wherein the first side stile can be connected to the top rail and the bottom rail, and a second side stile, wherein the second side stile can be connected to the top rail and the bottom rail. Th sash can also include an insulating glazing unit, wherein the insulating glazing unit can be disposed between the top rail and the bottom rail and between the first side stile and the second side stile. At least one of the bottom rail, the top rail, the first side stile, and the second side stile include a first lineal extrusion at least partially formed with a first composition. The first composition can include at least 5 wt. % fibers, and a first polymer resin. At least one of the bottom rail, the top rail, the first side stile, and the second side stile include a second lineal extrusion at least partially formed with a second composition. The second composition can include a second polymer resin.

In a second aspect, in addition to one or more of the preceding or following aspects, or in the alternative to some aspects, the at least 5 wt. % fibers can be glass fibers.

In a third aspect, in addition to one or more of the preceding or following aspects, or in the alternative to some aspects, the first composition can further include at least 10 wt. % glass fibers.

In a fourth aspect, in addition to one or more of the preceding or following aspects, or in the alternative to some aspects, the first composition can further include at least 30 wt. % glass fibers.

In a fifth aspect, in addition to one or more of the preceding or following aspects, or in the alternative to some aspects, the second polymer resin can be different than the first composition.

In a sixth aspect, in addition to one or more of the preceding or following aspects, or in the alternative to some aspects, the second polymer resin can be the same as the first composition.

In a seventh aspect, in addition to one or more of the preceding or following aspects, or in the alternative to some aspects, the first polymer resin can include polyvinylchloride.

In an eighth aspect, in addition to one or more of the preceding or following aspects, or in the alternative to some aspects, the second polymer resin can include polyvinylchloride.

In a ninth aspect, in addition to one or more of the preceding or following aspects, or in the alternative to some aspects, the second composition can be a neat polymer formulation.

In a tenth aspect, in addition to one or more of the preceding or following aspects, or in the alternative to some aspects, the second composition can be a neat PVC formulation.

In an eleventh aspect, in addition to one or more of the preceding or following aspects, or in the alternative to some aspects, the second composition can further include at least 5 wt. % wood particles.

In a twelfth aspect, in addition to one or more of the preceding or following aspects, or in the alternative to some aspects, the second composition can further include at least 10 wt. % wood particles.

In a thirteenth aspect, in addition to one or more of the preceding or following aspects, or in the alternative to some aspects, the second composition can further include at least 30 wt. % wood particles.

In a fourteenth aspect, in addition to one or more of the preceding or following aspects, or in the alternative to some aspects, the second composition can have less than 1 wt. % glass fibers.

In a fifteenth aspect, in addition to one or more of the preceding or following aspects, or in the alternative to some aspects, portions at least partially formed with the first composition exhibit less thermal bow than portions at least partially formed with the second composition.

In a sixteenth aspect, in addition to one or more of the preceding or following aspects, or in the alternative to some aspects, the fenestration assembly exhibits less thermal bow than an otherwise identical fenestration assembly formed with only the second composition.

In a seventeenth aspect, in addition to one or more of the preceding or following aspects, or in the alternative to some aspects, one of the first side stile and the second side stile include the first lineal extrusion at least partially formed with the first composition, and the other of the first side stile and the second side stile include the second lineal extrusion at least partially formed with the second composition.

In an eighteenth aspect, in addition to one or more of the preceding or following aspects, or in the alternative to some aspects, the first side stile and the second side stile can be at least 30 inches in length.

In a nineteenth aspect, in addition to one or more of the preceding or following aspects, or in the alternative to some aspects, the stile can include the first composition at a length of 30 inches exhibits thermal bow of less than 0.06 inches upon thermal cycling with a peak to trough temperature change of at least 180 degrees fahrenheit.

In a twentieth aspect, in addition to one or more of the preceding or following aspects, or in the alternative to some aspects, the fenestration assembly can be a casement window, an awning window, or a gliding window.

In a twenty-first aspect, in addition to one or more of the preceding or following aspects, or in the alternative to some aspects, the fenestration assembly can be a casement window, an awning window, a gliding window, a double-hung window, or a single-hung window.

In a twenty-second aspect, in addition to one or more of the preceding or following aspects, or in the alternative to some aspects, the first side stile can be a pivoting-side stile and includes the first lineal extrusion at least partially formed with the first composition, and the second side stile can be an opening-side stile and includes the second lineal extrusion at least partially formed with the second composition.

In a twenty-third aspect, in addition to one or more of the preceding or following aspects, or in the alternative to some aspects, the first side stile can be an opening-side stile and includes the first lineal extrusion at least partially formed with the first composition, and the second side stile can be a pivoting-side stile and includes the second lineal extrusion at least partially formed with the second composition.

In a twenty-fourth aspect, in addition to one or more of the preceding or following aspects, or in the alternative to some aspects, the first side stile can be an opening-side stile and includes the first lineal extrusion at least partially formed with the first composition, and the second side stile can be a pivoting-side stile and can be also at least partially formed with the first composition.

In a twenty-fifth aspect, in addition to one or more of the preceding or following aspects, or in the alternative to some aspects, the first lineal extrusion can include a coextrusion, wherein the coextrusion can be at least partially formed with the first composition and the second composition.

In a twenty-sixth aspect, in addition to one or more of the preceding or following aspects, or in the alternative to some aspects, the first lineal extrusion can include a coextrusion, wherein the coextrusion can be at least partially formed with the first composition and the second composition. The first side stile can be a pivoting-side stile and includes the first lineal extrusion at least partially formed with the first composition and the second composition. The second side stile can be an opening-side stile and includes the second lineal extrusion at least partially formed with the second composition.

In a twenty-seventh aspect, in addition to one or more of the preceding or following aspects, or in the alternative to some aspects, the first lineal extrusion can include a coextrusion, wherein the coextrusion can be at least partially formed with the first composition and the second composition. The first side stile can be an opening-side stile and include the first lineal extrusion at least partially formed with the first composition and the second composition. The second side stile can be a pivoting-side stile and include the second lineal extrusion at least partially formed with the second composition.

In a twenty-eighth aspect, in addition to one or more of the preceding or following aspects, or in the alternative to some aspects, the first lineal extrusion can include a coextrusion. The coextrusion can be at least partially formed with the first composition and the second composition. The first side stile can be an opening-side stile and include the first lineal extrusion at least partially formed with the first composition and the second composition and the second side stile can be a pivoting-side stile and also includes a coextrusion at least partially formed with the first composition and the second composition.

In a twenty-ninth aspect, in addition to one or more of the preceding or following aspects, or in the alternative to some aspects, the first lineal extrusion can include a coextrusion. The coextrusion can be at least partially formed with the first composition and the second composition. At least one of the bottom rail and the top rail includes the first lineal extrusion.

In a thirtieth aspect, in addition to one or more of the preceding or following aspects, or in the alternative to some aspects, the top rail includes the first lineal extrusion at least partially formed with the first composition and the bottom rail includes the second lineal extrusion at least partially formed with the second composition.

In a thirty-first aspect, in addition to one or more of the preceding or following aspects, or in the alternative to some aspects, the bottom rail includes the first lineal extrusion at least partially formed with the first composition and the top rail includes the second lineal extrusion at least partially formed with the second composition.

In a thirty-second aspect, in addition to one or more of the preceding or following aspects, or in the alternative to some aspects, the bottom rail and the top rail can be at least 30 inches in length.

In a thirty-third aspect, in addition to one or more of the preceding or following aspects, or in the alternative to some aspects, the bottom rail at a length of 30 inches exhibits thermal bow of less than 0.06 inches upon thermal cycling with a peak to trough temperature change of at least 180 degrees fahrenheit.

In a thirty-fourth aspect, in addition to one or more of the preceding or following aspects, or in the alternative to some aspects, the fenestration assembly can be a casement window, an awning window, a gliding window, a sliding window, a transom window, a picture window, a double-hung window, or a single-hung window.

In a thirty-fifth aspect, in addition to one or more of the preceding or following aspects, or in the alternative to some aspects, the fenestration assembly can be a casement window, an awning window, or a gliding window.

In a thirty-sixth aspect, a fenestration assembly can be included having a sash or a frame. The sash or a frame can include a first lineal member, a second lineal member, a third lineal member, wherein the third lineal member can be connected to the second lineal member and the first lineal member, and a fourth lineal member, wherein the fourth lineal member can be connected to the second lineal member and the first lineal member. At least one of the first lineal member, the second lineal member, the third lineal member, and the fourth lineal member include a first lineal extrusion at least partially formed with a first composition. The first composition can include at least 5 wt. % fibers and a first polymer resin. At least one of the first lineal member, the second lineal member, the third lineal member, and the fourth lineal member include a second lineal extrusion at least partially formed with a second composition. The second composition can include a second polymer resin.

In a thirty-seventh aspect, in addition to one or more of the preceding or following aspects, or in the alternative to some aspects, the at least 5 wt. % fibers can be glass fibers.

In a thirty-eighth aspect, in addition to one or more of the preceding or following aspects, or in the alternative to some aspects, the first composition can further include at least 10 wt. % glass fibers.

In a thirty-ninth aspect, in addition to one or more of the preceding or following aspects, or in the alternative to some aspects, the first composition can further include at least 30 wt. % glass fibers.

In a fortieth aspect, in addition to one or more of the preceding or following aspects, or in the alternative to some aspects, the second polymer resin can be different than the first composition.

In a forty-first aspect, in addition to one or more of the preceding or following aspects, or in the alternative to some aspects, the second polymer resin can be the same as the first composition.

In a forty-second aspect, in addition to one or more of the preceding or following aspects, or in the alternative to some aspects, the first polymer resin can include polyvinylchloride.

In a forty-third aspect, in addition to one or more of the preceding or following aspects, or in the alternative to some aspects, the second polymer resin can include polyvinylchloride.

In a forty-fourth aspect, in addition to one or more of the preceding or following aspects, or in the alternative to some aspects, the second composition can be a neat polymer formulation.

In a forty-fifth aspect, in addition to one or more of the preceding or following aspects, or in the alternative to some aspects, the second composition can be a neat PVC formulation.

In a forty-sixth aspect, in addition to one or more of the preceding or following aspects, or in the alternative to some aspects, the second composition can further include at least 5 wt. % wood particles.

In a forty-seventh aspect, in addition to one or more of the preceding or following aspects, or in the alternative to some aspects, the second composition can further include at least 10 wt. % wood particles.

In a forty-eighth aspect, in addition to one or more of the preceding or following aspects, or in the alternative to some aspects, the second composition can further include at least 30 wt. % wood particles.

In a forty-ninth aspect, in addition to one or more of the preceding or following aspects, or in the alternative to some aspects, the second composition can have less than 1 wt. % glass fibers.

In a fiftieth aspect, in addition to one or more of the preceding or following aspects, or in the alternative to some aspects, wherein portions at least partially formed with the first composition exhibit less thermal bow than portions at least partially formed with the second composition.

In a fifty-first aspect, in addition to one or more of the preceding or following aspects, or in the alternative to some aspects, the fenestration assembly exhibits less thermal bow than an otherwise identical fenestration assembly formed with only the second composition.

In a fifty-second aspect, in addition to one or more of the preceding or following aspects, or in the alternative to some aspects, the sash or a frame can further include an insulating glazing unit, wherein the insulating glazing unit can be disposed between the second lineal member and the first lineal member and between the third lineal member and the fourth lineal member.

In a fifty-third aspect, a fenestration assembly can be included having a lineal extrusion. The lineal extrusion defines one or more interior hollows, the lineal extrusion can include an interior portion, wherein the interior portion can be adjacent an interior side of the fenestration assembly, an exterior portion, wherein the exterior portion can be adjacent an exterior side of the fenestration assembly, and a middle portion, wherein the middle portion interconnects the exterior portion and the interior portion. A first composition can be included, the first composition can include at least 5 wt. % fibers and a first polymer resin. A second composition can be included, the second composition can include a second polymer resin. The second composition can be different than the first composition. At least one of the interior portion, the middle portion, and the exterior portion includes greater than 50% by volume of the first composition and another of the interior portion, the middle portion, and the exterior portion includes greater than 50% by volume of the second composition.

In a fifty-fourth aspect, in addition to one or more of the preceding or following aspects, or in the alternative to some aspects, wherein at least two of the interior portion, the middle portion, and the exterior portion includes greater than 50% by volume of the first composition and the remaining one of the interior portion, the middle portion, and the exterior portion includes greater than 50% by volume of the second composition.

In a fifty-fifth aspect, in addition to one or more of the preceding or following aspects, or in the alternative to some aspects, wherein one of the interior portion, the middle portion, and the exterior portion includes greater than 50% by volume of the first composition and the remaining two of the interior portion, the middle portion, and the exterior portion includes greater than 50% by volume of the second composition.

In a fifty-sixth aspect, in addition to one or more of the preceding or following aspects, or in the alternative to some aspects, the interior portion, the middle portion, and the exterior portion each include at least 5% of the total interior to exterior thickness of the lineal extrusion.

In a fifty-seventh aspect, in addition to one or more of the preceding or following aspects, or in the alternative to some aspects, the interior portion, the middle portion, and the exterior portion each include at least 10% of the total interior to exterior thickness of the lineal extrusion.

In a fifty-eighth aspect, in addition to one or more of the preceding or following aspects, or in the alternative to some aspects, the at least 5 wt. % fibers are glass fibers.

In a fifty-ninth aspect, in addition to one or more of the preceding or following aspects, or in the alternative to some aspects, the first composition can further include at least 10 wt. % glass fibers.

In a sixtieth aspect, in addition to one or more of the preceding or following aspects, or in the alternative to some aspects, the first composition can further include at least 30 wt. % glass fibers.

In a sixty-first aspect, in addition to one or more of the preceding or following aspects, or in the alternative to some aspects, the second composition can further include at least 5 wt. % wood particles.

In a sixty-second aspect, in addition to one or more of the preceding or following aspects, or in the alternative to some aspects, the second composition can further include at least 10 wt. % wood particles.

In a sixty-third aspect, in addition to one or more of the preceding or following aspects, or in the alternative to some aspects, the second composition can further include at least 30 wt. % wood particles.

In a sixty-fourth aspect, in addition to one or more of the preceding or following aspects, or in the alternative to some aspects, the first polymer resin can include polyvinylchloride.

In a sixty-fifth aspect, in addition to one or more of the preceding or following aspects, or in the alternative to some aspects, the second polymer resin can include polyvinylchloride.

In a sixty-sixth aspect, in addition to one or more of the preceding or following aspects, or in the alternative to some aspects, the second composition can be a neat polyvinylchloride formulation.

In a sixty-seventh aspect, in addition to one or more of the preceding or following aspects, or in the alternative to some aspects, the lineal extrusion can be at least 30 inches in length.

In a sixty-eighth aspect, in addition to one or more of the preceding or following aspects, or in the alternative to some aspects, the lineal extrusion at a length of 30 inches exhibits thermal bow of less than 0.06 inches upon thermal cycling with a peak to trough temperature change of at least 180 degrees fahrenheit.

In a sixty-ninth aspect, in addition to one or more of the preceding or following aspects, or in the alternative to some aspects, the lineal extrusion can be a fenestration structural member.

In a seventieth aspect, in addition to one or more of the preceding or following aspects, or in the alternative to some aspects, the lineal extrusion can be a fenestration frame member.

In a seventy-first aspect, in addition to one or more of the preceding or following aspects, or in the alternative to some aspects, the lineal extrusion can be a fenestration sash member.

In a seventy-second aspect, in addition to one or more of the preceding or following aspects, or in the alternative to some aspects, the lineal extrusion can be a mull post.

In a seventy-third aspect, in addition to one or more of the preceding or following aspects, or in the alternative to some aspects, the lineal extrusion can be an astragal.

In a seventy-fourth aspect, a door assembly can be included having a door, and a thermal bow resistant structural member. The thermal bow resistant structural member can include a lineal coextrusion. The lineal coextrusion can include a first composition and a second composition. The first composition can include at least 5 wt. % fibers and a first polymer resin. The second composition can include a second polymer resin and the second composition can be different than the first composition.

In a seventy-fifth aspect, in addition to one or more of the preceding or following aspects, or in the alternative to some aspects, the thermal bow resistant structural member can further include a frame member.

In a seventy-sixth aspect, in addition to one or more of the preceding or following aspects, or in the alternative to some aspects, can further include a side lite or side panel, wherein the thermal bow resistant structural member can be disposed between the door and the side lite or side panel.

In a seventy-seventh aspect, in addition to one or more of the preceding or following aspects, or in the alternative to some aspects, the thermal bow resistant structural member can further include a mull post.

In a seventy-eighth aspect, in addition to one or more of the preceding or following aspects, or in the alternative to some aspects, the thermal bow resistant structural member can further include an astragal.

In a seventy-ninth aspect, in addition to one or more of the preceding or following aspects, or in the alternative to some aspects, the at least 5 wt. % fibers can be glass fibers.

In an eightieth aspect, in addition to one or more of the preceding or following aspects, or in the alternative to some aspects, the first composition can further include at least 10 wt. % glass fibers.

In an eighty-first aspect, in addition to one or more of the preceding or following aspects, or in the alternative to some aspects, the first composition can further include at least 30 wt. % glass fibers.

In an eighty-second aspect, in addition to one or more of the preceding or following aspects, or in the alternative to some aspects, the second composition can further include at least 5 wt. % wood particles.

In an eighty-third aspect, in addition to one or more of the preceding or following aspects, or in the alternative to some aspects, the second composition can further include at least 10 wt. % wood particles.

In an eighty-fourth aspect, in addition to one or more of the preceding or following aspects, or in the alternative to some aspects, the second composition can further include at least 30 wt. % wood particles.

In an eighty-fifth aspect, in addition to one or more of the preceding or following aspects, or in the alternative to some aspects, the first polymer resin can include polyvinylchloride.

In an eighty-sixth aspect, in addition to one or more of the preceding or following aspects, or in the alternative to some aspects, the second polymer resin can include polyvinylchloride.

In an eighty-seventh aspect, in addition to one or more of the preceding or following aspects, or in the alternative to some aspects, the second composition can be a neat polyvinylchloride formulation.

In an eighty-eighth aspect, in addition to one or more of the preceding or following aspects, or in the alternative to some aspects, the thermal bow resistant structural member can have a length of at least 30 inches.

In an eighty-ninth aspect, in addition to one or more of the preceding or following aspects, or in the alternative to some aspects, the thermal bow resistant structural member at a length of 30 inches exhibits thermal bow of less than 0.06 inches upon thermal cycling with a peak to trough temperature change of at least 180 degrees fahrenheit.

In a ninetieth aspect, in addition to one or more of the preceding or following aspects, or in the alternative to some aspects, the door assembly can further include a second side lite or side panel and a second thermal bow resistant mull post, wherein the second thermal bow resistant mull post can be disposed between the door and the second side lite or side panel. The second thermal bow resistant mull post can include a lineal coextrusion. The lineal coextrusion can include the first composition and the second composition.

In a ninety-first aspect, a fenestration assembly can be included having a sash. The sash can include a bottom rail, a top rail, a first side stile, wherein the first side stile can be connected to the top rail and the bottom rail, a second side stile, wherein the second side stile can be connected to the top rail and the bottom rail, and an insulating glazing unit, wherein the insulating glazing unit can be disposed between the top rail and the bottom rail and between the first side stile and the second side stile. At least one of the bottom rail, the top rail, the first side stile, and the second side stile include a first lineal extrusion at least partially formed with a first composition. The first composition can include at least 5 wt. % fibers and/or at least 5 wt. % particles and a first polymer resin. At least one of the bottom rail, the top rail, the first side stile, and the second side stile include a second lineal extrusion at least partially formed with a second composition. The second composition can include a second polymer resin.

In a ninety-second aspect, in addition to one or more of the preceding or following aspects, or in the alternative to some aspects, the at least 5 wt. % fibers and/or at least 5 wt. % particles can include glass fibers.

In a ninety-third aspect, in addition to one or more of the preceding or following aspects, or in the alternative to some aspects, the at least 5 wt. % fibers and/or at least 5 wt. % particles can include wood particles.

In a ninety-fourth aspect, in addition to one or more of the preceding or following aspects, or in the alternative to some aspects, the second polymer resin can be different than the first composition.

In a ninety-fifth aspect, in addition to one or more of the preceding or following aspects, or in the alternative to some aspects, the second polymer resin can be the same as the first composition.

In a ninety-sixth aspect, in addition to one or more of the preceding or following aspects, or in the alternative to some aspects, the first polymer resin can include polyvinylchloride.

In a ninety-seventh aspect, in addition to one or more of the preceding or following aspects, or in the alternative to some aspects, the second polymer resin can include polyvinylchloride.

In a ninety-eighth aspect, in addition to one or more of the preceding or following aspects, or in the alternative to some aspects, the second composition can be a neat polymer formulation.

In a ninety-ninth aspect, in addition to one or more of the preceding or following aspects, or in the alternative to some aspects, the second composition can be a neat PVC formulation.

In a one hundredth aspect, in addition to one or more of the preceding or following aspects, or in the alternative to some aspects, the first side stile can be a pivoting-side stile and include the first lineal extrusion at least partially formed with the first composition and the second side stile can be an opening-side stile and include the second lineal extrusion at least partially formed with the second composition.

In a one hundred and first aspect, in addition to one or more of the preceding or following aspects, or in the alternative to some aspects, the first side stile can be an opening-side stile and includes the first lineal extrusion at least partially formed with the first composition. The second side stile can be a pivoting-side stile and include the second lineal extrusion at least partially formed with the second composition.

In a one hundred and second aspect, in addition to one or more of the preceding or following aspects, or in the alternative to some aspects, the first lineal extrusion can include a coextrusion. The coextrusion can be at least partially formed with the first composition and the second composition. The first side stile can be an opening-side stile and include the first lineal extrusion at least partially formed with the first composition and the second composition. The second side stile can be a pivoting-side stile and include the second lineal extrusion at least partially formed with the second composition.

In a one hundred and third aspect, in addition to one or more of the preceding or following aspects, or in the alternative to some aspects, the first lineal extrusion can include a coextrusion. The coextrusion can be at least partially formed with the first composition and the second composition. The first side stile can be a pivoting-side stile and include the first lineal extrusion at least partially formed with the first composition and the second composition. The second side stile can be an opening-side stile and include the second lineal extrusion at least partially formed with the second composition.

In a one hundred and fourth aspect, in addition to one or more of the preceding or following aspects, or in the alternative to some aspects, the first side stile can be an opening-side stile and include the first lineal extrusion at least partially formed with the first composition and the second side stile can be a pivoting-side stile and can be also at least partially formed with the first composition.

In a one hundred and fifth aspect, in addition to one or more of the preceding or following aspects, or in the alternative to some aspects, wherein the first side stile can be a pivoting-side stile and include the first lineal extrusion at least partially formed with the first composition. The second side stile can be an opening-side stile and can be also at least partially formed with the first composition.

In a one hundred and sixth aspect, in addition to one or more of the preceding or following aspects, or in the alternative to some aspects, the bottom rail includes the first lineal extrusion at least partially formed with the first composition and the top rail includes the second lineal extrusion at least partially formed with the second composition.

In a one hundred and seventh aspect, in addition to one or more of the preceding or following aspects, or in the alternative to some aspects, the top rail includes the first lineal extrusion at least partially formed with the first composition. The bottom rail includes the second lineal extrusion at least partially formed with the second composition.

In a one hundred and eighth aspect, a sash assembly can be included having an insulating glazing unit and a thermal bow resistant structural member. The thermal bow resistant structural member can include a lineal coextrusion. The lineal coextrusion can include a first composition and a second composition. The first composition can include at least 5 wt. % fibers and a first polymer resin. The second composition can include a second polymer resin. The second composition can be different than the first composition.

In a one hundred and ninth aspect, in addition to one or more of the preceding or following aspects, or in the alternative to some aspects, the thermal bow resistant structural member can further include a sash frame member.

In a one hundred and tenth aspect, in addition to one or more of the preceding or following aspects, or in the alternative to some aspects, the at least 5 wt. % fibers can be glass fibers.

In a one hundred and eleventh aspect, in addition to one or more of the preceding or following aspects, or in the alternative to some aspects, the first composition can further include at least 10 wt. % glass fibers.

In a one hundred and twelfth aspect, in addition to one or more of the preceding or following aspects, or in the alternative to some aspects, the first composition can further include at least 30 wt. % glass fibers.

In a one hundred and thirteenth aspect, in addition to one or more of the preceding or following aspects, or in the alternative to some aspects, the second composition can further include at least 5 wt. % wood particles.

In a one hundred and fourteenth aspect, in addition to one or more of the preceding or following aspects, or in the alternative to some aspects, the second composition can further include at least 10 wt. % wood particles.

In a one hundred and fifteenth aspect, in addition to one or more of the preceding or following aspects, or in the alternative to some aspects, the second composition can further include at least 30 wt. % wood particles.

In a one hundred and sixteenth aspect, in addition to one or more of the preceding or following aspects, or in the alternative to some aspects, the first polymer resin can include polyvinylchloride.

In a one hundred and seventeenth aspect, in addition to one or more of the preceding or following aspects, or in the alternative to some aspects, the second polymer resin can include polyvinylchloride.

In a one hundred and eighteenth aspect, in addition to one or more of the preceding or following aspects, or in the alternative to some aspects, the second composition can be a neat polyvinylchloride formulation.

In a one hundred and nineteenth aspect, in addition to one or more of the preceding or following aspects, or in the alternative to some aspects, there can be four thermal bow resistant structural members surrounding the insulating glazing unit.

In a one hundred and twentieth aspect, a fenestration assembly can be included having a multi-part frame member, the multi-part frame member can include a first lineal extrusion, the first lineal extrusion can include a first composition, the first composition can include at least 5 wt. % fibers, and a first polymer resin, a second lineal extrusion, the second lineal extrusion can include a second composition, wherein the second composition can be different than the first composition, wherein the first lineal extrusion defines one or more interior hollows, and wherein the second lineal extrusion defines one or more interior hollows.

In a one hundred and twenty-first aspect, in addition to one or more of the preceding or following aspects, or in the alternative to some aspects, the at least 5 wt. % fibers can be glass fibers.

In a one hundred and twenty-second aspect, in addition to one or more of the preceding or following aspects, or in the alternative to some aspects, the first composition can further include at least 10 wt. % glass fibers.

In a one hundred and twenty-third aspect, in addition to one or more of the preceding or following aspects, or in the alternative to some aspects, the first composition can further include at least 30 wt. % glass fibers.

In a one hundred and twenty-fourth aspect, in addition to one or more of the preceding or following aspects, or in the alternative to some aspects, the first polymer resin can include polyvinylchloride.

In a one hundred and twenty-fifth aspect, in addition to one or more of the preceding or following aspects, or in the alternative to some aspects, the second composition can include a second polymer resin.

In a one hundred and twenty-sixth aspect, in addition to one or more of the preceding or following aspects, or in the alternative to some aspects, the second polymer resin can include polyvinylchloride.

In a one hundred and twenty-seventh aspect, in addition to one or more of the preceding or following aspects, or in the alternative to some aspects, the second composition can include at least 5 wt. % wood particles.

In a one hundred and twenty-eighth aspect, in addition to one or more of the preceding or following aspects, or in the alternative to some aspects, the second composition can include at least 10 wt. % wood particles.

In a one hundred and twenty-ninth aspect, in addition to one or more of the preceding or following aspects, or in the alternative to some aspects, the second composition can include at least 30 wt. % wood particles.

In a one hundred and thirtieth aspect, in addition to one or more of the preceding or following aspects, or in the alternative to some aspects, the second composition can be a neat polyvinylchloride formulation.

In a one hundred and thirty-first aspect, in addition to one or more of the preceding or following aspects, or in the alternative to some aspects, wherein the first lineal extrusion can be an exterior fenestration structural member, and wherein the second lineal extrusion can be an interior fenestration structural member.

In a one hundred and thirty-second aspect, in addition to one or more of the preceding or following aspects, or in the alternative to some aspects, the fenestration assembly can be a window sash.

In a one hundred and thirty-third aspect, in addition to one or more of the preceding or following aspects, or in the alternative to some aspects, the fenestration assembly can be a door frame.

In a one hundred and thirty-fourth aspect, in addition to one or more of the preceding or following aspects, or in the alternative to some aspects, the first lineal extrusion and the second lineal extrusion can be fitted together.

In a one hundred and thirty-fifth aspect, in addition to one or more of the preceding or following aspects, or in the alternative to some aspects, the first lineal extrusion and the second lineal extrusion can be fitted together defining a receiving channel for an insulated glazing unit.

In a one hundred and thirty-sixth aspect, a fenestration assembly can be included having a lineal extrusion, wherein the lineal extrusion defines one or more interior hollows. The lineal extrusion can include a single-wall glass lip, wherein the single-wall glass lip can be adjacent an exterior side of the fenestration assembly. The single-wall glass lip at least partially defines a receiving channel for an insulating glazing unit. The single-wall glass lip can include greater than 50% by volume of a first composition, wherein the first composition can include at least 5 wt. % fibers and a first polymer resin.

In a one hundred and thirty-seventh aspect, in addition to one or more of the preceding or following aspects, or in the alternative to some aspects, the at least 5 wt. % fibers can be glass fibers.

In a one hundred and thirty-eighth aspect, in addition to one or more of the preceding or following aspects, or in the alternative to some aspects, the first composition can further include at least 10 wt. % glass fibers.

In a one hundred and thirty-ninth aspect, in addition to one or more of the preceding or following aspects, or in the alternative to some aspects, the first composition can further include at least 30 wt. % glass fibers.

In a one hundred and fortieth aspect, in addition to one or more of the preceding or following aspects, or in the alternative to some aspects, the first polymer resin can include polyvinylchloride.

In a one hundred and forty-first aspect, in addition to one or more of the preceding or following aspects, or in the alternative to some aspects, the lineal extrusion can further include a second composition, wherein the second composition can be different than the first composition.

In a one hundred and forty-second aspect, in addition to one or more of the preceding or following aspects, or in the alternative to some aspects, the second composition can include a second polymer resin.

In a one hundred and forty-third aspect, in addition to one or more of the preceding or following aspects, or in the alternative to some aspects, the second polymer resin can include polyvinylchloride.

In a one hundred and forty-fourth aspect, in addition to one or more of the preceding or following aspects, or in the alternative to some aspects, the second composition can include at least 5 wt. % wood particles.

In a one hundred and forty-fifth aspect, in addition to one or more of the preceding or following aspects, or in the alternative to some aspects, the second composition can include at least 10 wt. % wood particles.

In a one hundred and forty-sixth aspect, in addition to one or more of the preceding or following aspects, or in the alternative to some aspects, the second composition can include at least 30 wt. % wood particles.

In a one hundred and forty-seventh aspect, in addition to one or more of the preceding or following aspects, or in the alternative to some aspects, the second composition can be a neat polyvinylchloride formulation.

In a one hundred and forty-eighth aspect, in addition to one or more of the preceding or following aspects, or in the alternative to some aspects, the lineal extrusion can be a fenestration sash member.

In a one hundred and forty-ninth aspect, in addition to one or more of the preceding or following aspects, or in the alternative to some aspects, the single-wall glass lip can be thicker than adjoining wall portions of the lineal extrusion.

In a one hundred and fiftieth aspect, in addition to one or more of the preceding or following aspects, or in the alternative to some aspects, the single-wall glass lip includes a tapered portion such that a base of the single-wall glass lip can be thicker than a tip of the single-wall glass lip.

In a one hundred and fifty-first aspect, in addition to one or more of the preceding or following aspects, or in the alternative to some aspects, a wall defining an exterior wall of the lineal extrusion can be thicker than other wall portions of the lineal extrusion. In a one hundred and fifty-second aspect, in addition to one or more of the preceding or following aspects, or in the alternative to some aspects, a base the single-wall glass lip intersects with another wall portion of the lineal extrusion forming a joint, wherein the joint can be thicker than other intersections between other wall members of the lineal extrusion.

In a one hundred and fifty-third aspect, in addition to one or more of the preceding or following aspects, or in the alternative to some aspects, a base the single-wall glass lip intersects with another wall portion of the lineal extrusion forming a joint, wherein a surface feature can be disposed over an exterior side of the joint.

In a one hundred and fifty-fourth aspect, in addition to one or more of the preceding or following aspects, or in the alternative to some aspects, the surface feature can be a raised portion.

In a one hundred and fifty-fifth aspect, in addition to one or more of the preceding or following aspects, or in the alternative to some aspects, the surface feature can be a ridge.

In a one hundred and fifty-sixth aspect, in addition to one or more of the preceding or following aspects, or in the alternative to some aspects, the surface feature can be a depression.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a schematic elevation view of an entry door system in accordance with various embodiments herein.

FIG. 2 is a schematic view of a structural member in accordance with various embodiments herein.

FIG. 3 is a schematic view of a structural member exhibiting thermal bowing in accordance with various embodiments herein.

FIG. 4 is a cross-sectional view of a mull post in accordance with various embodiments herein.

FIG. 5 is a schematic elevation view of patio door in accordance with various embodiments herein.

FIG. 6 is a perspective view of a window assembly in accordance with various embodiments herein.

FIG. 7 is a cross-sectional view of a lineal structural member in accordance with various embodiments herein.

FIG. 8 is a cross-sectional view of a lineal structural member in accordance with various embodiments herein.

FIG. 9 is a cross-sectional view of a lineal structural member in accordance with various embodiments herein.

FIG. 10 is a cross-sectional view of a casement sash member in accordance with various embodiments herein.

FIG. 11 is a cross-sectional view of a lineal structural member in accordance with various embodiments herein.

FIG. 12 is a cross-sectional view of a lineal structural member in accordance with various embodiments herein.

FIG. 13 is a cross-sectional view of a lineal structural member in accordance with various embodiments herein.

FIG. 14 is a cross-sectional view of a double-hung sash member in accordance with various embodiments herein.

FIG. 15 is a cross-sectional view of a double-hung sash member in accordance with various embodiments herein.

FIG. 16 is a cross-sectional view of a double-hung sash member in accordance with various embodiments herein.

FIG. 17 is a cross-sectional view of a double-hung sash member in accordance with various embodiments herein.

FIG. 18 is a cross-sectional view of a lineal structural member in accordance with various embodiments herein.

FIG. 19 is a cross-sectional view of a lineal structural member in accordance with various embodiments herein.

FIG. 20 is a cross-sectional view of a lineal structural member in accordance with various embodiments herein.

FIG. 21 is a cross-sectional view of a lineal structural member in accordance with various embodiments herein.

FIG. 22 is a cross-sectional view of a lineal structural member in accordance with various embodiments herein.

FIG. 23 is a cross-sectional view of a mull post in accordance with various embodiments herein.

FIG. 24 is a cross-sectional view of a mull post in accordance with various embodiments herein.

FIG. is a cross-sectional view of a mull post in accordance with various embodiments herein.

FIG. 26 is a cross-sectional view of a lineal structural member in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

As referenced above, exterior portions of fenestrations can be exposed to substantial air temperature swings that may be exacerbated by absorbing energy from sunlight. Some materials may exhibit a degree of thermal expansion and/or thermal deformation which can lead to thermal bowing of fenestration components which may negatively affect durability and/or aesthetics.

However, embodiments herein can reduce thermal bowing of fenestration components. For example, the use of two different materials or compositions strategically and selectively placed in specific locations of the fenestration can greatly reduce thermal bowing effects. For example, a first composition can include an amount of fibers (such as at least 5 wt. % fibers) and a first polymer resin. A second composition can include a second polymer resin. These two compositions can be used to form different components of a fenestration to resist thermal bowing and/or can be used as different portions of a coextrusion that resists thermal bowing. Fenestration components herein can include components of entry doors, patio doors, windows, and the like.

As a more specific example, in some embodiments some components of a sash (such as one or more of four lineal extrusions or one or more of a top rail, bottom rail, first side stile, and/or second side stile) can be formed using a first composition while the other components of the sash can be formed using a second composition. Also, some components of a sash can be formed using both compositions as part of a coextrusion while other components may only include one composition or the other, or another composition entirely.

As another example, a lineal extrusion for a fenestration assembly can include an interior side portion (a portion disposed toward the interior of the structure when the fenestration is installed), an exterior side portion (a portion disposed toward the exterior of the structure when the fenestration is installed), and a middle portion between the interior side portion and the exterior side portion, such as interconnecting the exterior portion and the interior portion. As before, a first composition can include some amount of fibers (such as at least 5 wt. % fibers) and a first polymer resin and a second composition can include a second polymer resin. At least one of the interior portion, the middle portion, and the exterior portion can be formed of the first composition and another of the interior portion, the middle portion, and the exterior portion can be formed of the second composition.

As still another example, a door assembly herein can include a door and a thermal bow resistant structural member. The thermal bow resistant structural member can include a lineal coextrusion. The lineal coextrusion can include a first composition comprising some amount of fibers, such as at least 5 wt. % fibers, and a first polymer resin. The lineal coextrusion can also include a second composition comprising a second polymer resin.

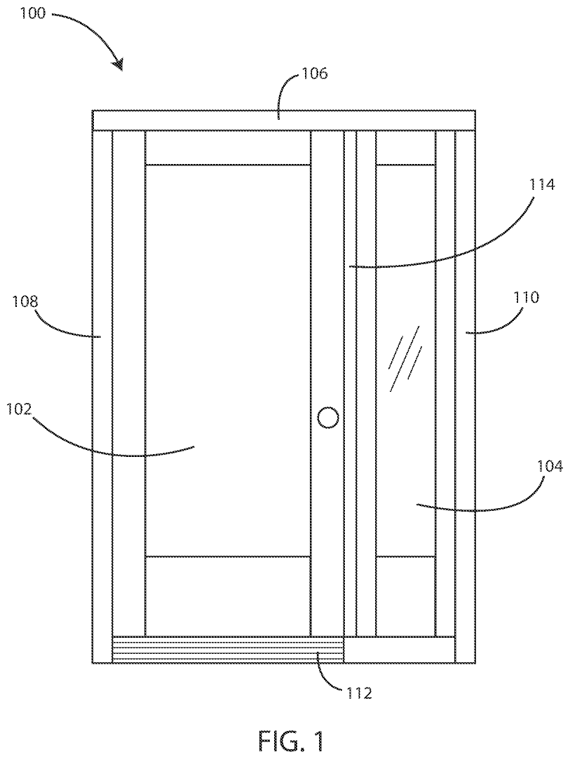

Referring now to FIG. 1, a schematic elevation view is shown of an entry door system 100 in accordance with various embodiments herein. The entry door system 100 is one example of a fenestration system or assembly herein. The entry door system 100 can include a door 102 along with a side lite or side panel 104. The entry door system 100 can include frame members such as a head jamb 106, a first side jamb 108, a second side jamb 110, and a sill assembly 112. The frame members can also include a mull post 114.

The entry door system 100 can include one or more thermal bow resistant structural members. For example, one or more of the head jamb 106, first side jamb 108, second side jamb 110, sill assembly 112, and mull post 114 can be formed using material compositions as described herein to reduce thermal bow.

Issues of thermal bowing can be more substantial with components that are relatively long and therefore the need to mitigate thermal bowing can become more important with longer components. For example, in some embodiments herein, thermal bow resistant components or structural members may have a length of at least 24, 30, 36, 42, 48, 60, 72, 84, 96, or more inches, or a length falling within a range between any of the foregoing.

Many different components of a fenestration can be formed with bow resistant structural members herein. However, bowing issues can be more substantial with components that are less supported by other structural members and/or less supported by the elements of the structure into which the fenestration is installed such as the rough opening. By way of example, mull posts and astragals may be particularly susceptible to thermal bowing and, as such, can be formed with bow resistant structural members herein. Further, certain portions of a sash with certain window types (such as casement windows, awning windows, and gliding windows) can include one or more rails or stiles that are more susceptible to thermal bowing. As such, these window components can be formed with bow resistant structural members herein.

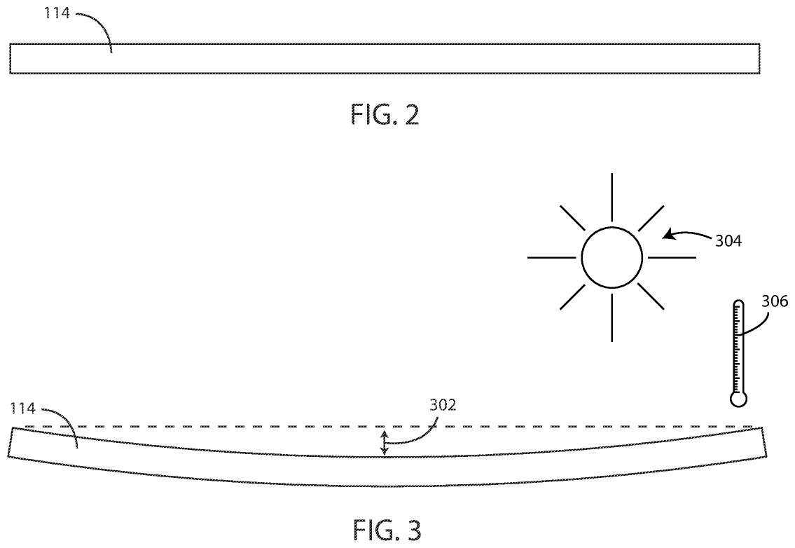

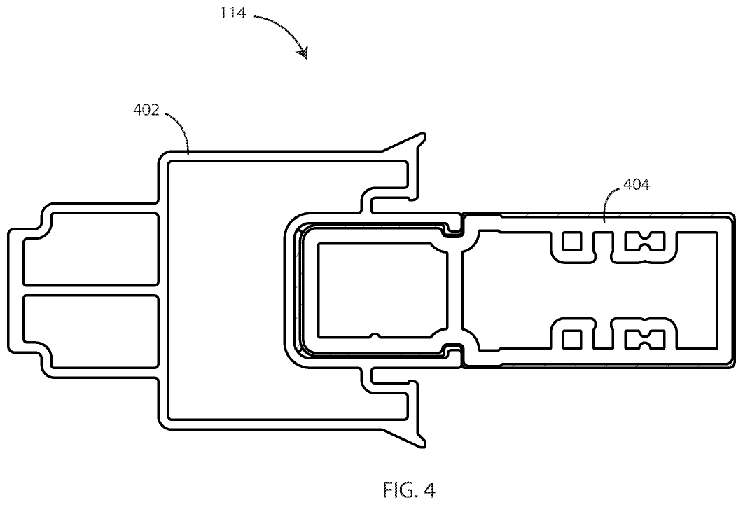

Referring now to FIG. 2, a schematic view of a structural member is shown in accordance with various embodiments herein. The structural member may be, for example, a mull post 114, or another structural member. As initially manufactured, the mull post 114 can be very straight and substantially perfect in form. However, thermal exposure can cause changes. Referring now to FIG. 3, a schematic view of a structural member exhibiting thermal bowing is shown in accordance with various embodiments herein. In this example, the mull post 114 is exposed to sunlight 304 and high air temperatures 306 at some points in time and shade or darkness and low temperatures at other times creating thermal cycling exposure.

In this example, the mull post 114 is illustrated to have undergone a degree of a thermal bow 302. The specific magnitude of thermal bowing can vary based on, amongst other factors, the length of the item, but in some embodiments can be at least 0.05, 0.1, 0.2, 0.3, 0.4, 0.5, 0.6, 0.7, 0.8, 0.9, or 1 inch or more, or an amount falling within a range between any of the foregoing. However, the use of bow resistant structural members herein can substantially reduce the magnitude of thermal bowing. For example, thermal bowing in a specific fenestration component can be reduced by at least 10, 20, 30, 40, 50, 60, 70, 80, or even 90 percent or more by the use of bow resistant structural members herein. As such, components herein can exhibit less than 1, 0.9, 0.8, 0.7, 0.6, 0.5, 0.4, 0.3, 0.2, 0.1, 0.075, 0.05, 0.04, or 0.03 inches of thermal bowing. In some embodiments, bow resistant structural members herein, as standardized for a length of 30 inches for measurement purposes, can exhibit thermal bow after repeated thermal cycling (such as exposing an exterior side to at least 35 to 100 cycles of about than 180 degrees fahrenheit peak to trough while holding the interior side at a constant temperature) to reach a steady-state bow amount of less than 0.06, 0.055, 0.05, 0.045, 0.04, 0.035, 0.03 inches or less, or an amount falling within a range between any of the foregoing.

Components herein can be formed using a first composition, a second composition, or both a first and second composition. In some embodiments, when two different compositions are used, they may be part of a coextrusion. However, in some embodiments, a component may be formed using two different composition subparts that are then joined together. In some embodiments, components herein can also be formed using a third composition, a fourth composition, or more. A third composition can be, for example, a capping layer disposed around the outside perimeter of the component or structural member in cross-section.

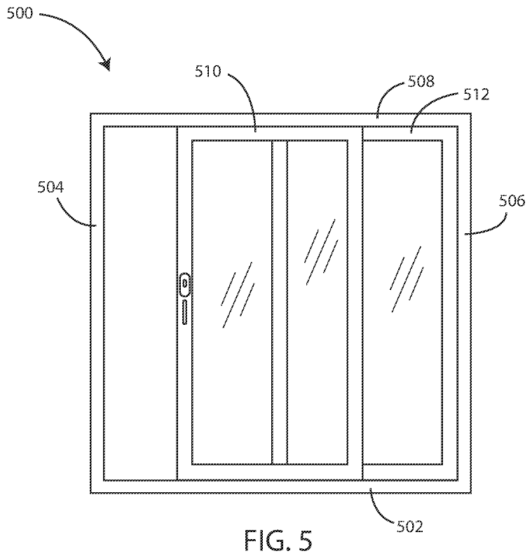

Referring now to FIG. 4, a cross-sectional view of a mull post 114 is shown in accordance with various embodiments herein. In this example, the mull post 114 includes an outside piece 402 and an inside piece 404 that are joined together to form the mull post 114. However, in other embodiments, the mull post 114 may simply be a unitary whole without subparts and/or can be a coextrusion of various compositions. In the example, shown, the outside piece 402 can be formed using a first composition, a second composition, or both a first and second composition. The inside piece 404 can be formed using a first composition, a second composition, or both a first and second composition.

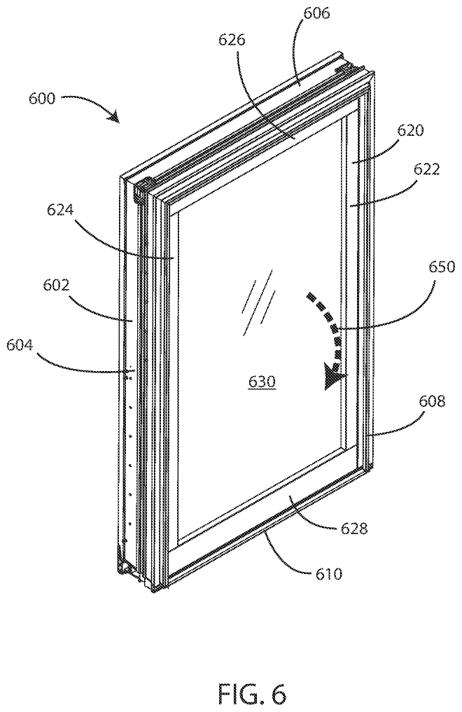

It will be appreciated that various components of entry door systems can be formed using bow resistant structural members herein including various frame members for entry doors. Beyond entry door systems, other fenestrations that can be made using bow resistant structural members herein can include various components of patio door systems. Referring now to FIG. 5, a schematic elevation view of patio door 500 is shown in accordance with various embodiments herein. The patio door 500 includes frame members such as a patio door sill assembly 502, a first jamb 504, a second jamb 506, and a head jamb 508. The patio door 500 also includes a sliding door panel 510 and a fixed door panel 512. Any of the frame members (and other types of frame members not shown in this view), the door panels, and/or other structural members of the system can be formed using bow resistant structural members herein to address issues of thermal bow.

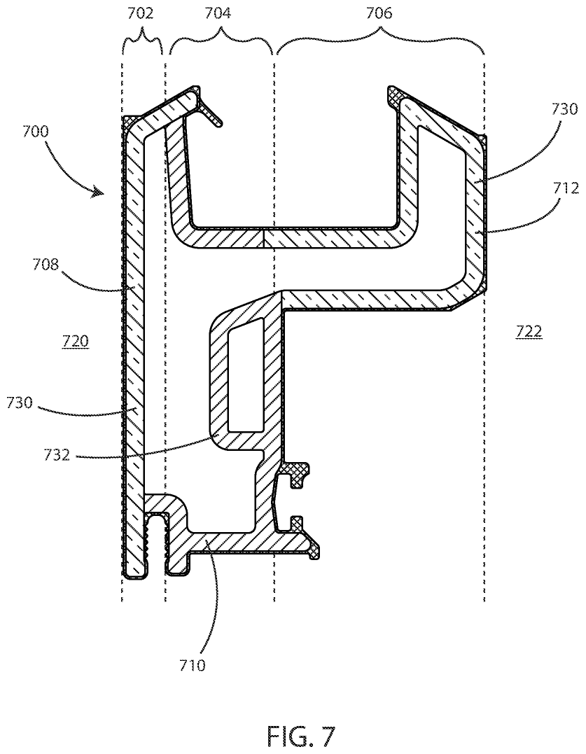

In addition to door systems (entry door systems and patio door systems), other fenestrations that can be made using bow resistant structural members herein can include window systems. Referring now to FIG. 6, a perspective view of a window assembly 600 is shown in accordance with various embodiments herein. The window assembly 600 includes a frame assembly 602. The frame assembly 602 includes a first side jamb 604, a head jamb 606, a second side jamb 608, and a sill 610. In various embodiments one or more of the first side jamb 604, head jamb 606, second side jamb 608, and sill 610 can be bow resistant structural members herein.

The window assembly 600 shown in FIG. 6 includes a sash 620. The sash 620 includes a first stile 622, a second stile 624, a top rail 626, and a bottom rail 628. In various embodiments one or more of the first stile 622, second stile 624, top rail 626, and bottom rail 628 can be bow resistant structural members herein. The sash 620 includes a glass subassembly 630 therein.

Window assemblies herein can include all types of windows including, but not limited to, double-hung, single-hung, casement, awning, sliding, gliding, transom, and picture windows amongst others. With certain styles of window, one portion of a sash may stay close to the frame while another portion swings out 650 and away from the frame when the window is opened. For example, casement windows include sashes that swing outward as do awning windows. Such window types can include an opening-side (or locking side) stile or rail (the side that swings outward—in the example of FIG. 6 this is first stile 622) and a pivoting-side (or hinge side) stile or rail (the side that stays close to the frame and pivots—in the example of FIG. 6 this is second stile 624).

While not intending to be bound by theory, in some configurations the opening-side structural member (such as a stile or rail) may be more susceptible to thermal bowing issues. As such, in some embodiments, an opening-side structural member (such as a stile or rail) is formed with a bow resistant structural members herein while other sides or components are formed with other materials that may be lower in cost. In some configurations, it can be particularly important to make sure that the pivoting-side structural member does not exhibit substantial thermal bow. For example, various pieces of hardware (such as a snugger, or the like) may be designed to engage with or otherwise fit against the pivoting-side structural member. As such, in some embodiments, a pivoting-side structural member (such as a stile or rail) is formed with a bow resistant structural members herein while other sides or components are formed with other materials that may be lower in cost.

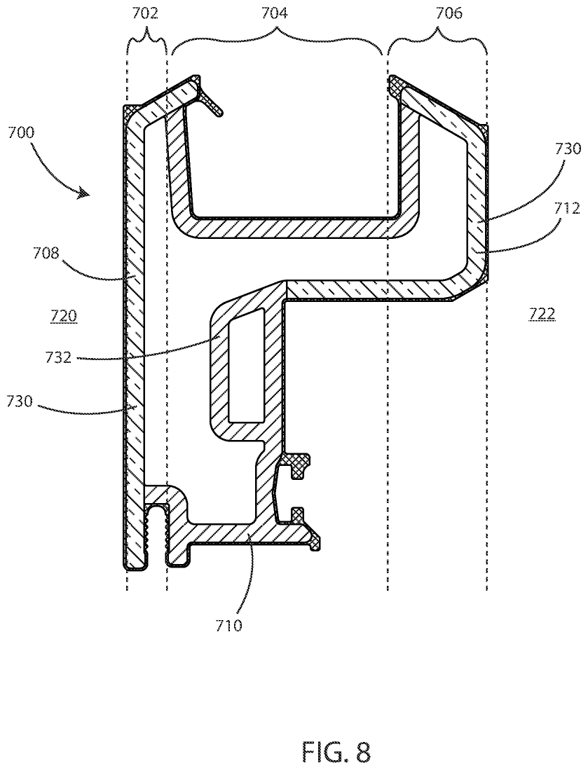

However, in still other embodiments, both the opening-side stile or rail and the pivoting-side stile or rail both can be formed with a bow resistant structural member. In various embodiments, any or all of the window components or door components can be formed with bow resistant structural members herein. Therefore, in some embodiments multiple members (two, three, or more) of the same unit (which could be a frame, sash, or other structure) can take on the same configuration (such as that illustrated in FIG. 7 or in accordance with other embodiments herein) or even all members of the same unit can take on the same configuration. In other cases, only some members (such as only one, two, or three, etc.) of the same unit have such a structure while other members of the same unit have a different structure.

Referring now to FIG. 7, a cross-sectional view of a lineal structural member 700 is shown in accordance with various embodiments herein. This lineal structural member 700 can be formed with a combination of a first composition herein and a second composition herein such that it functions as a bow resistant structural member. The lineal extrusion 700 includes an exterior portion 702, a middle portion 704, and an interior portion 706. In this example, the middle portion 704 interconnects the exterior portion 702 and the interior portion 706. In various embodiments, the lineal structural member 700 defines one or more interior 722 hollows. The exterior portion 702 includes an exterior wall portion 708. The middle portion 704 includes a middle wall portion 710. The interior portion 706 includes an interior wall portion 712.

FIG. 7 also illustrates the exterior 720 and interior 722 sides with respect to the exterior and interior when the fenestration unit is installed in a structure. As such, the exterior portion 702 is closest to the exterior 720 and the interior portion 706 is closest to the interior 722.

It will be appreciated that similar features as described with respect to FIG. 7 are also applicable to various fenestration components, including, but not limited to, structural or frame members, and/or other components such as panel components, sash components, mull posts, astragals, mullions, muntins, sills, jambs, jamb liners, casings, rails, stiles, stools, aprons, casements, transoms, trim, and the like.

As illustrated, the specific lineal structural member 700 can include a coextrusion, wherein the coextrusion can be formed with the first composition 730 and the second composition 732. In some embodiments, the first composition 730 can include at least 5 wt. % fibers and a first polymer resin while the second composition 732 can include a second polymer resin. In some embodiments, the at least 5 wt. % fibers can specifically be glass fibers. In some embodiments, the first composition can include at least 5, 10, 20, 30 or 40 wt. % glass fibers.

In some embodiments, the second polymer resin is different than the first composition, but in other embodiment they are the same. In some embodiments, the first polymer resin can be polyvinylchloride. In some embodiments, the second polymer resin can be polyvinylchloride. In some examples, the second composition is a neat polymer composition, such as a neat PVC composition lacking fibers and particles. However, in some embodiments, the second composition can include at least 5 wt. % wood particles, 10 wt. % wood particles, 30 wt. % wood particles, or more. In various embodiments, the second composition has less than 5, 4, 3, 2, or 1 wt. % glass fibers. In various embodiments the second composition has no glass fibers.

In this example, the exterior portion 702 and the interior portion 706 can be formed predominantly with the first composition 730, while the middle portion 704 can formed predominantly with the second composition 732. For example, the exterior portion 702 and the interior portion 706 can be formed with greater than 50% by weight and/or 50% by volume of the first composition 730 and the middle portion 704 can be formed with greater than 50% by weight and/or 50% by volume of the second composition 732.

However, in some embodiments, the materials used to form different portions can be switched. In various embodiments, at least one of the interior portion 706, the middle portion 704, and the exterior portion 702 is predominantly formed with the first composition and the remaining two of the interior portion 706, the middle portion 704, and the exterior portion 702 is predominantly formed with the second composition. Alternatively, in various embodiments at least two of the interior portion 706, the middle portion 704, and the exterior portion 702 is predominantly formed with the first composition and the remaining one of the interior portion 706, the middle portion 704, and the exterior portion 702 is predominantly formed with the second composition.

While not intending to be bound by theory, the use of a first composition 730 herein for exterior portion 702 (and in some cases also the interior portion 706) provides resistance to thermal bowing and enhanced strength.

The relative sizes of the exterior portion 702, middle portion 704, and interior portion 706 can vary. In some embodiments, the interior portion 706, the middle portion 704, and the exterior portion 702 each comprise at least 5, 10, 20, or 30% of the total interior 722 to exterior 720 thickness of the lineal extrusion 700. In some embodiments, sizes of the exterior portion 702, middle portion 704, and interior portion 706 are different from one another. For example, in some embodiments, the exterior portion 702 and the interior portion 706 may each make up about 20 to 30% of the total thickness of the lineal extrusion 700 while the middle portion 704 may make up the remaining 40 to 60% of the total thickness. In some embodiments, at least one of the exterior portion 702 and the interior portion 706 make up about 1, 2, 3, 4, 5, 7.5, 10, 15, or 30% of the total thickness of the lineal extrusion 700 while the middle portion 704 makes up the remaining portion of the total thickness.

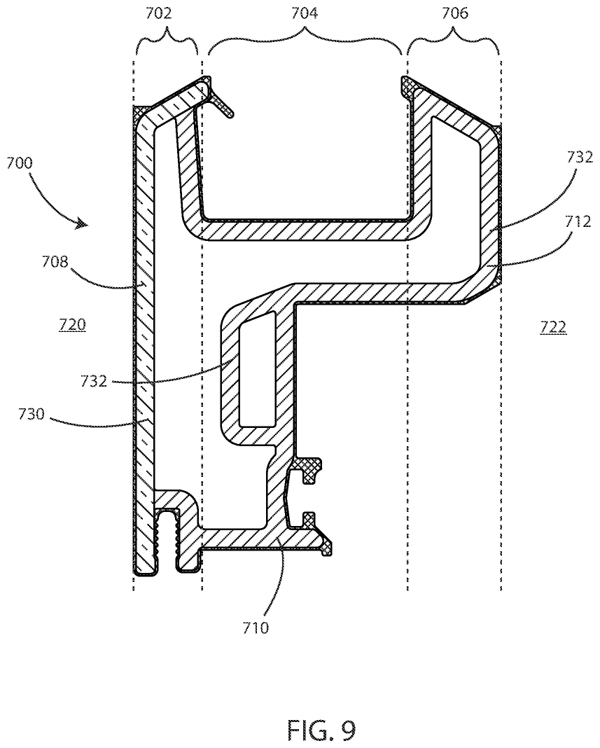

Referring now to FIG. 8, a cross-sectional view of a lineal structural member is shown in accordance with various embodiments herein. FIG. 8 is generally similar to FIG. 7. As such, FIG. 8 shows a lineal extrusion 700 including an exterior portion 702, a middle portion 704, an interior portion 706, an exterior wall portion 708, a middle wall portion 710, and an interior wall portion 712, with the wall portions formed of a first composition 730 and a second composition 732, along with illustrating the exterior 720 and interior 722 sides. However, in FIG. 8, the relative amounts of the first composition 730 and the second composition 732 vary somewhat from the example of FIG. 7. In specific, the interior portion 706 may include some amount of the second composition 732 but is still predominantly (such as greater than 50% by volume) formed of the first composition 730. In addition, in FIG. 8, transitions between materials do not occur in the middle of flat wall sections.

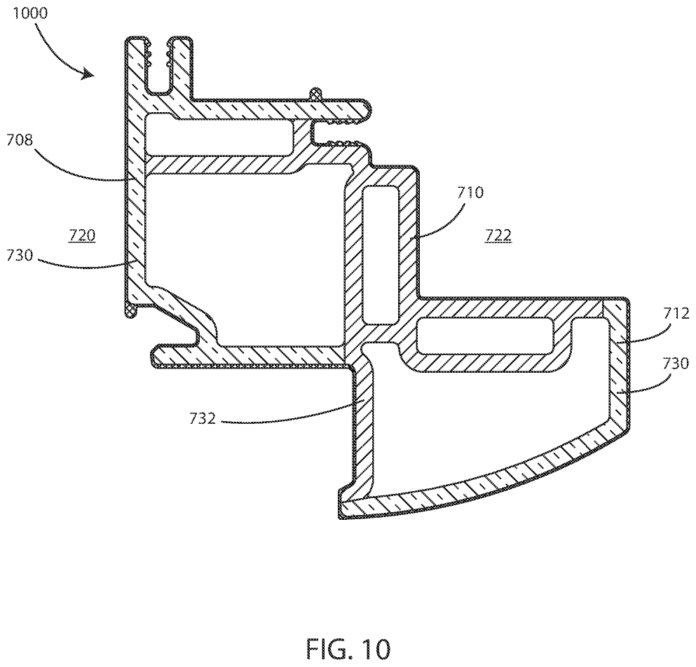

Referring now to FIG. 9, a cross-sectional view of a lineal structural member is shown in accordance with various embodiments herein. FIG. 8 is generally similar to FIG. 7. As such, FIG. 9 shows a lineal extrusion 700 including an exterior portion 702, a middle portion 704, an interior portion 706, an exterior wall portion 708, a middle wall portion 710, and an interior wall portion 712, with the wall portions formed of a first composition 730 and a second composition 732, along with illustrating the exterior 720 and interior 722 sides. However, in FIG. 9, the relative amounts of the first composition 730 and the second composition 732 vary somewhat from the example of FIGS. 7 and 8. In specific, both the middle portion 704, and the interior portion 706 are completely formed with the second composition 732, while the exterior portion 702 is predominantly formed with the first composition 730.

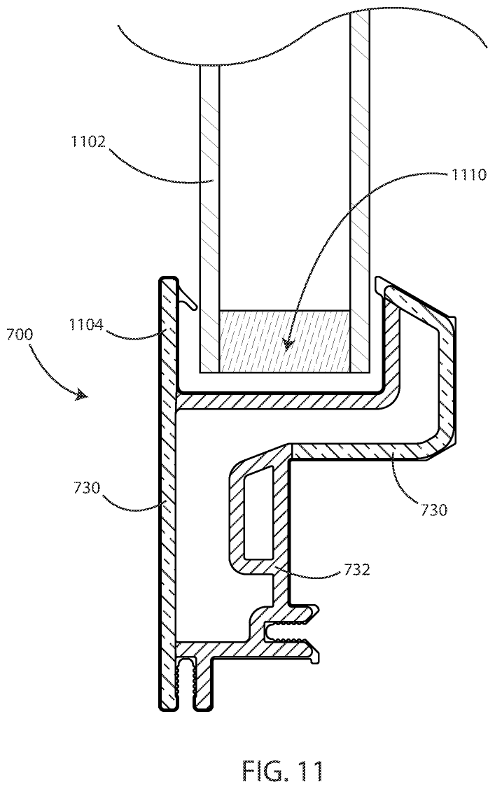

As many different structural and/or framing components are contemplated herein to be formed as bow resistant structural members, the profiles of such bow resistant structural members can vary substantially. Referring now to FIG. 10, a cross-sectional view of a casement sash member 1000 is shown in accordance with various embodiments herein. The casement sash member 1000 is formed as a bow resistant structural member and include an exterior portion including an exterior wall portion 708, a middle portion including a middle wall portion 710, and an interior portion including an interior wall portion 712. FIG. 10 also illustrates the exterior 720 and interior 722. The exterior wall portion 708 can be formed of a first composition 730. The middle wall portion 710 can be formed of a second composition 732. The interior wall portion 712 can be formed of the first composition 730. In some embodiments, the exterior wall portion 708 can be defined as the exterior most wall of the lineal structural member. In some embodiments, the interior wall portion 712 can be defined as the interior most wall of the lineal structural member.

In some cases, there can be a desire to incorporate thicker glass constructions (such as with triple pane insulating glazing units) in products that were originally designed for thinner, dual pane constructions. It can be particularly desirable to do this without increasing the overall thickness of the product. In embodiments herein, stiffer/stronger composite materials herein can be utilized allowing for a thin, single wall exterior glass lip that allows for the incorporation of thicker glass constructions without thickening the sash.

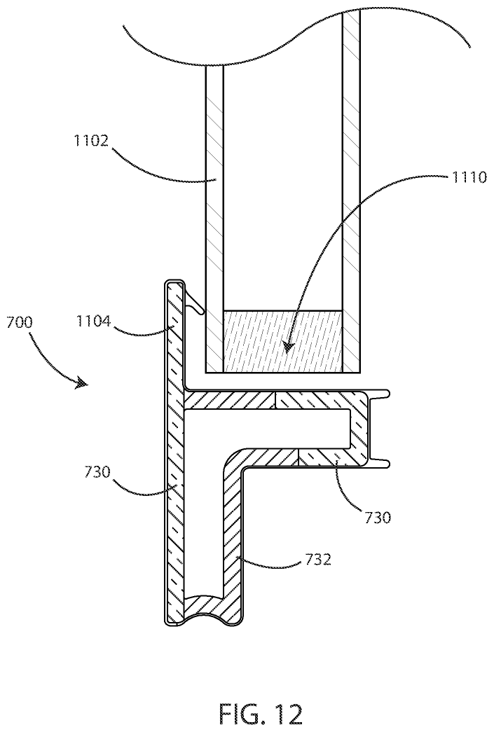

Referring now to FIG. 11, a cross-sectional view is shown of a lineal structural member 700 (in the form of a fenestration frame member) in accordance with various embodiments herein. In this example the lineal structural member 700 includes portions formed of first composition 730 and portions formed of second composition 732. However, this example also shows the lineal structural member 700 including a single-walled glass lip 1104 (or glass retaining lip). The glass lip 1104 is disposed on the exterior side of an insulating glazing unit 1102 (after assembly of the fenestration) and serves to retain the insulating glazing unit 1102 from the exterior side. The glass lip 1104 at least partially defines a receiving channel 1110 into which the insulating glazing unit 1102 fits. The insulating glazing unit 1102 can include various components such as two or more sheets of glass and a spacing structure. While not intending to be bound by theory, structural strength provided by the first composition 730 allows for the glass lip 1104 to be a single wall (e.g., a single wall extending unsupported by adjacent walls) design versus comparable double wall designs. In some embodiments, the single-walled glass lip 1104 extends at least about 0.5 cm, 1 cm, 1.5 cm, 2 cm, 2.5 cm, 3 cm or more unsupported by an adjacent wall (or a distance falling within a range between any of the foregoing. The single wall design allows for more compact, thinner structures on the exterior side of the fenestration.

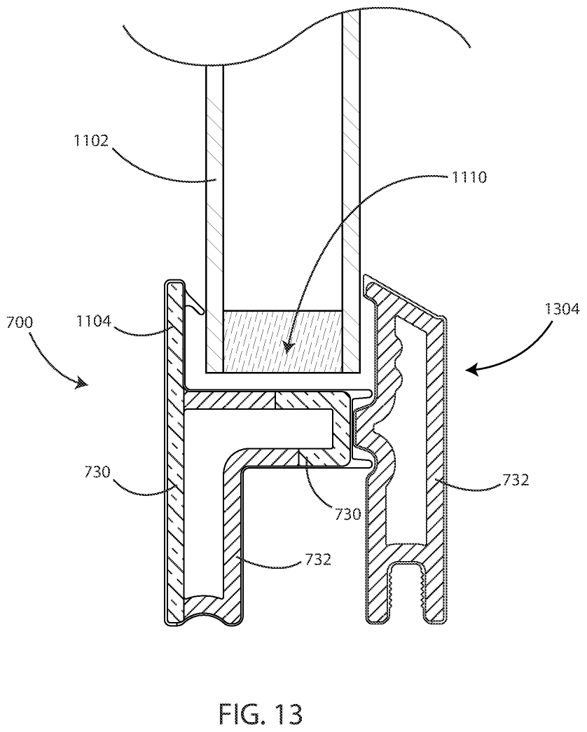

Referring now to FIG. 12, a cross-sectional view is shown of a lineal structural member 700 in accordance with various embodiments herein. As with FIG. 11, a lineal structural member 700 includes portions formed of first composition 730, portions formed of second composition 732, and a single-walled glass lip 1104. As before, the glass lip 1104 is disposed on the exterior side of an insulating glazing unit 1102 (after assembly of the fenestration) and serves to retain the insulating glazing unit 1102 from the exterior side. The glass lip 1104 at least partially defines a receiving channel 1110 into which the insulating glazing unit 1102 fits. In this example, the lineal structural member 700 shown only retains a side of the insulating glazing unit 1102 and is designed to work with another component for full retention of the insulating glazing unit 1102. For example, the lineal structural member 700 shown in FIG. 12 could be an exterior piece of a two-piece frame assembly, with the exterior piece formed with portions of the first composition 730 and portions formed of second composition 732.

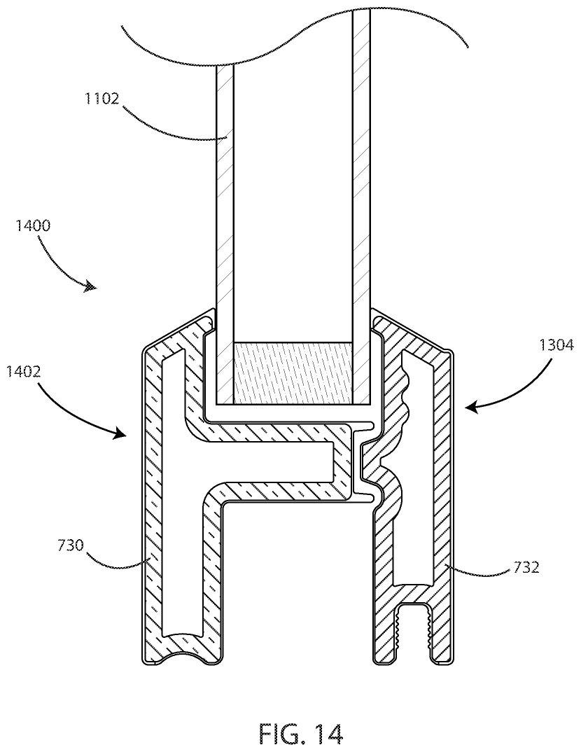

Referring now to FIG. 13, a cross-sectional view of a lineal structural member 700 is shown in accordance with various embodiments herein. The lineal structural member 700 is shown along with an interior piece 1304. As with FIG. 12, a lineal structural member 700 includes portions formed of first composition 730, portions formed of second composition 732, and a single-walled glass lip 1104. The interior piece 1304 can be formed of the second composition 732. Alternatively, the interior piece can be formed of the first composition 730 or can include portions formed of the first composition 730 and portions formed of the second composition 732.

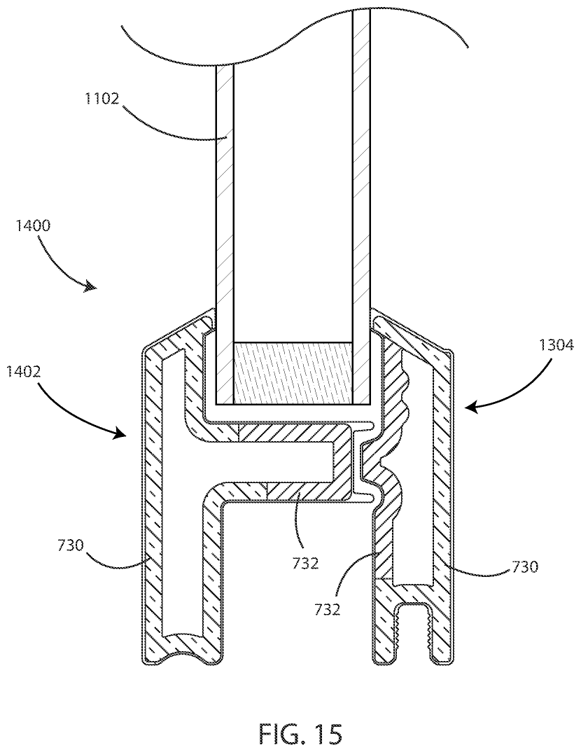

It will be appreciated that in various embodiments herein, two-piece (or multi-piece) components (sash components, frame components, etc.) can be formed using various combinations of the first composition and portions the second composition. For example, an exterior piece of a sash component can be formed with the first composition while an interior piece of a sash component can be formed with the second composition. Referring now to FIG. 14, a cross-sectional view of a double-hung sash member 1400 (as an example of a frame assembly) is shown in accordance with various embodiments herein. In this example, the exterior piece 1402 of the double-hung sash member 1400 is formed with a first composition 730 and the interior piece 1304 is formed with the second composition. In operation, the exterior piece 1402 may be exposed to much more significant swings of temperature than the interior piece 1304 and therefore may benefit from the desirable structural properties afforded by using the first composition 730. While this view shows the exterior piece 1402 formed entirely from the first composition 730 (other than a capstock layer) it will be appreciated that in some embodiments the exterior piece 1402 can be formed with portions made of the first composition 730 and portions made of the second composition 732. In addition, while this view shows the interior piece 1304 formed entirely from the second composition 732 (other than a capstock layer) it will be appreciated that in some embodiments the interior piece 1304 can be formed with portions made of the second composition 732 and portions made of the first composition 730.

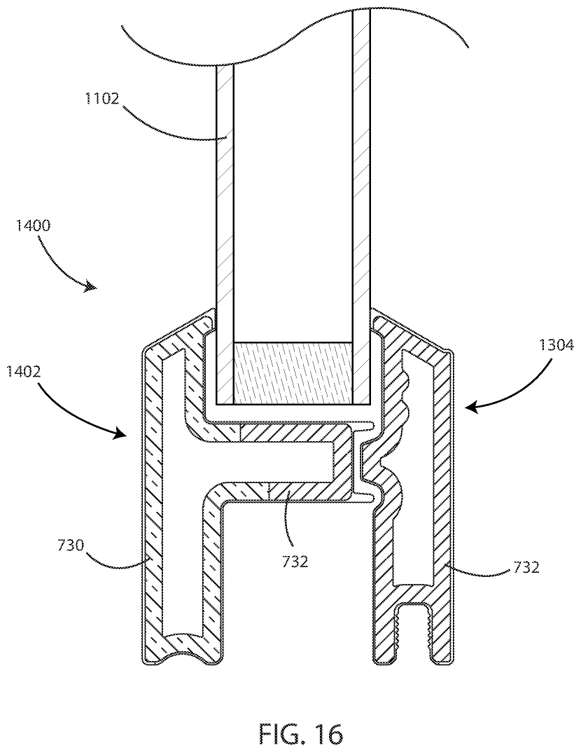

Referring now to FIG. 15, a cross-sectional view of a double-hung sash member 1400 is shown in accordance with various embodiments herein. In this example, the exterior piece 1402 of the double-hung sash member 1400 is formed with a first composition 730 and a second composition 732, while the interior piece 1304 is also formed with the first composition 730 and the second composition 732.

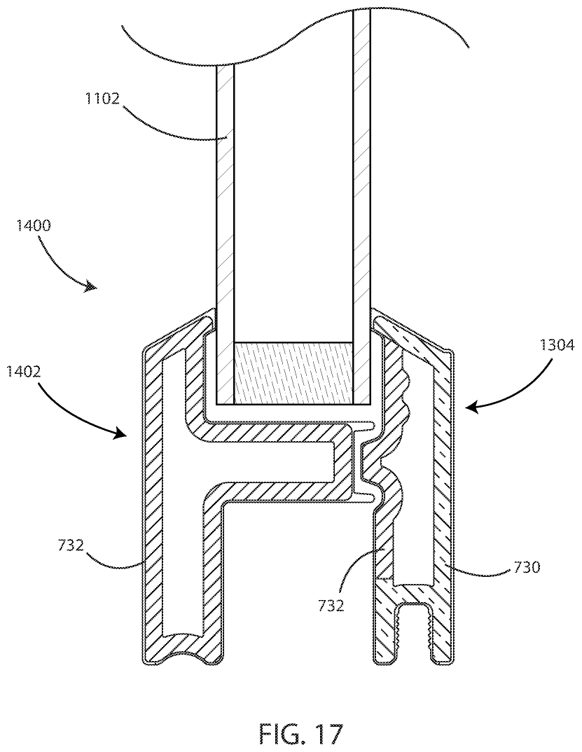

Referring now to FIG. 16, a cross-sectional view of a double-hung sash member 1400 is shown in accordance with various embodiments herein. In this example, the exterior piece 1402 of the double-hung sash member 1400 is formed with a first composition 730 and a second composition 732, while the interior piece 1304 is also formed with the second composition 732.

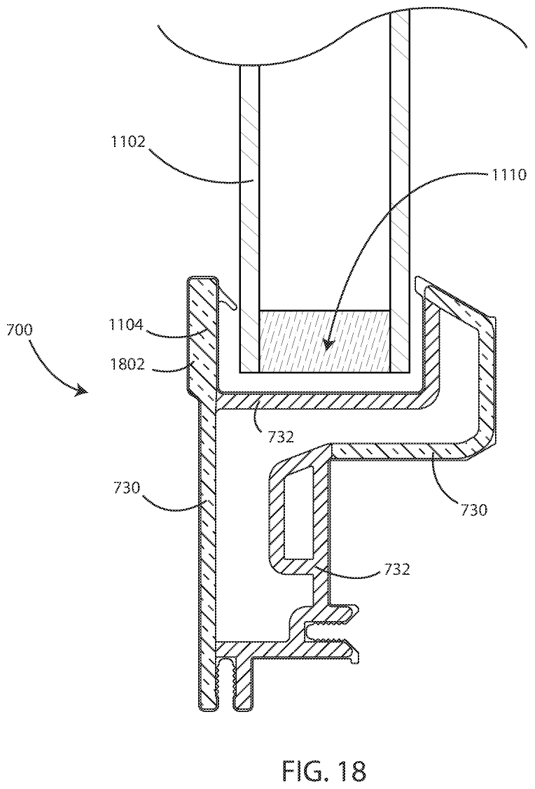

Referring now to FIG. 17, a cross-sectional view of a double-hung sash member 1400 is shown in accordance with various embodiments herein. In this example, the exterior piece 1402 of the double-hung sash member 1400 is formed with a second composition 732, while the interior piece 1304 is also formed with a first composition 730 and the second composition 732.

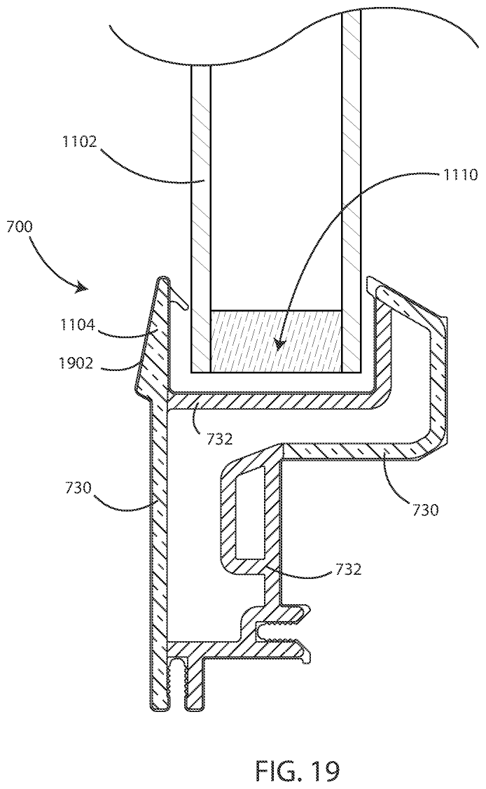

Referring now to FIG. 18, a cross-sectional view of a lineal structural member 700 is shown in accordance with various embodiments herein. FIG. 18 is generally similar to FIG. 11. In this example the lineal structural member 700 includes portions formed of first composition 730 and portions formed of second composition 732. This example also shows the lineal structural member 700 including a single-walled glass lip 1104 (or glass retaining lip). The glass lip 1104 is disposed on the exterior side of an insulating glazing unit 1102 (after assembly of the fenestration) and serves to retain the insulating glazing unit 1102 from the exterior side. The glass lip 1104 at least partially defines a receiving channel 1110 into which the insulating glazing unit 1102 fits. In this embodiment, the single-walled glass lip 1104 includes a thickened portion 1802 that is thicker than adjoining wall portions. For example, the thickened portion 1802 can be about 1.1, 1.2, 1.3, 1.4, 1.5, 1.75, 2, 2.5, 3, or even 4 times as thick as adjoining wall portions. The thickened portion 1802 can specifically be in the area of the single-walled glass lip 1104 and can increase the strength thereof.

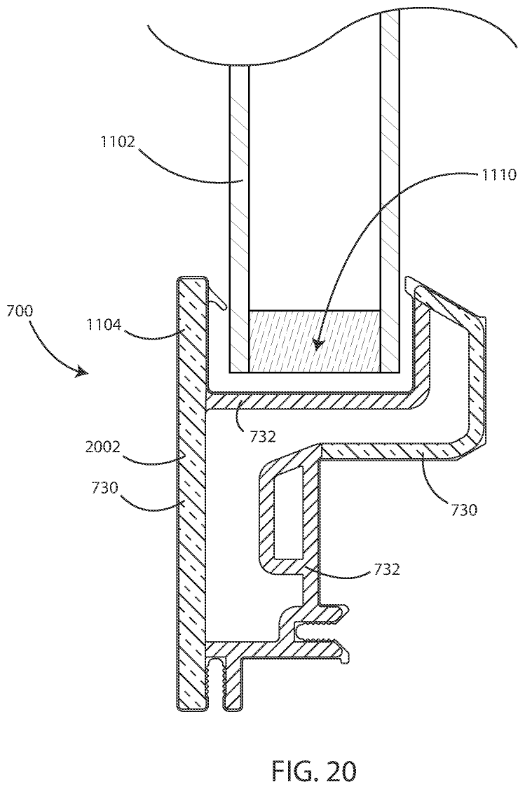

Referring now to FIG. 19, a cross-sectional view of a lineal structural member 700 is shown in accordance with various embodiments herein. FIG. 19 is generally similar to FIG. 11. As before, the lineal structural member 700 includes portions formed of first composition 730 and portions formed of second composition 732. This example also shows the lineal structural member 700 including a single-walled glass lip 1104, receiving channel 1110, and insulating glazing unit 1102. In this embodiment, the single-walled glass lip 1104 includes a tapered portion 1902 such that the base of the single-walled glass lip 1104 is thicker than a tip portion of the same. The tapered portion 1902 can provide additional strength to the single-walled glass lip 1104 near its base where such additional strength may be needed most.

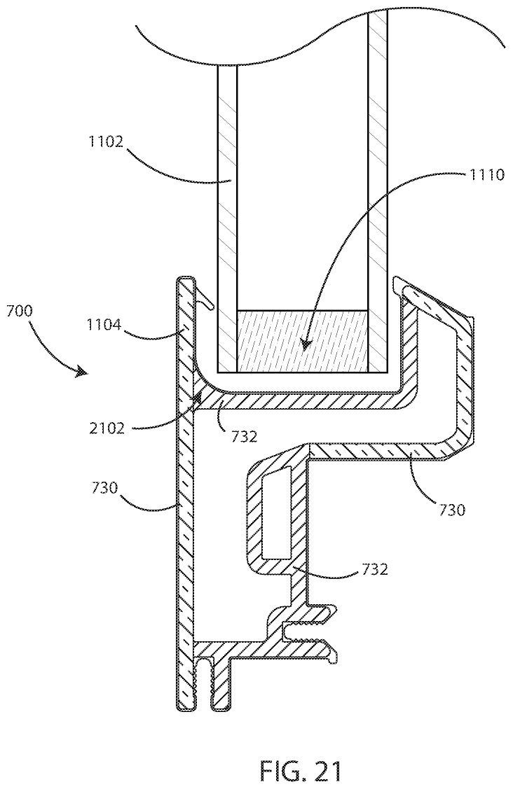

Referring now to FIG. 20 a cross-sectional view of a lineal structural member 700 is shown in accordance with various embodiments herein. FIG. 20 is generally similar to FIG. 11. As before, the lineal structural member 700 includes portions formed of first composition 730 and portions formed of second composition 732. This example also shows the lineal structural member 700 including a single-walled glass lip 1104, receiving channel 1110, and insulating glazing unit 1102. In this embodiment, the entire exterior facing wall 2002, including the single-walled glass lip 1104, can be thicker than other walls of the lineal structural member 700. This configuration can provide additional strength to the entire exterior facing wall 2002.

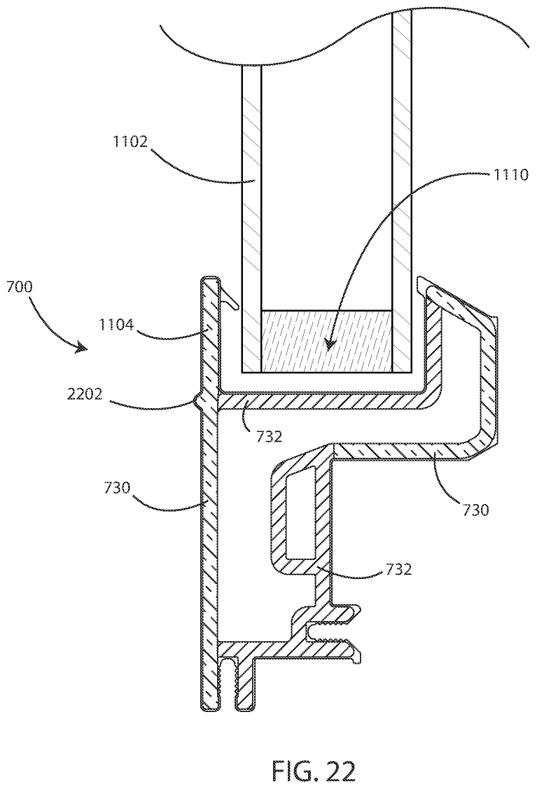

Referring now to FIG. 21 a cross-sectional view of a lineal structural member 700 is shown in accordance with various embodiments herein. FIG. 20 is generally similar to FIG. 11. As before, the lineal structural member 700 includes portions formed of first composition 730 and portions formed of second composition 732. This example also shows the lineal structural member 700 including a single-walled glass lip 1104, receiving channel 1110, and insulating glazing unit 1102. In this embodiment, a joint 2102 between the base of the single-walled glass lip 1104 and an adjoining interior wall can be thickened to provide additional strength. For example, the joint 2102 can exhibit a different radius of curvature than other intersections between walls of the lineal structural member 700, making the joint 2102 effectively thicker.

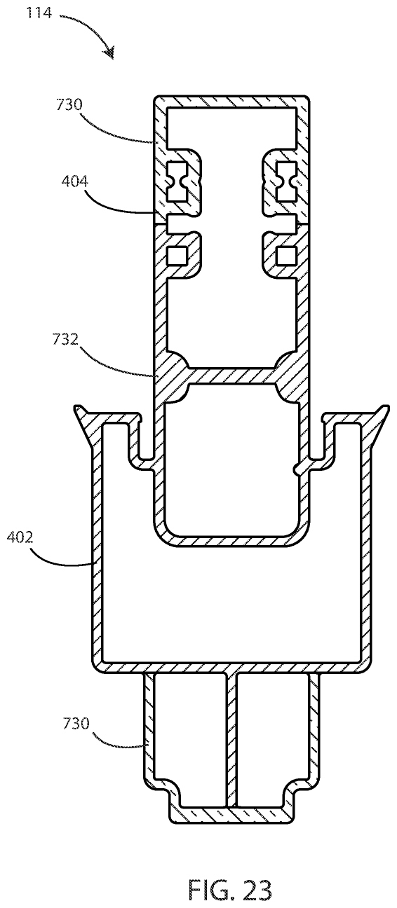

Referring now to FIG. 22 a cross-sectional view of a lineal structural member 700 is shown in accordance with various embodiments herein. FIG. 22 is generally similar to FIG. 11. As before, the lineal structural member 700 includes portions formed of first composition 730 and portions formed of second composition 732. This example also shows the lineal structural member 700 including a single-walled glass lip 1104, receiving channel 1110, and insulating glazing unit 1102. In this embodiment, a surface feature 2202 is included on an opposite side from where an interior wall meets the base of the single-walled glass lip 1104. The surface feature 2202 can, for example, a raised portion such as a ridge or other element that sticks out from the adjacent surface of the single-walled glass lip 1104. In other embodiments, the surface feature 2202 can be a depression instead of a raised portion.

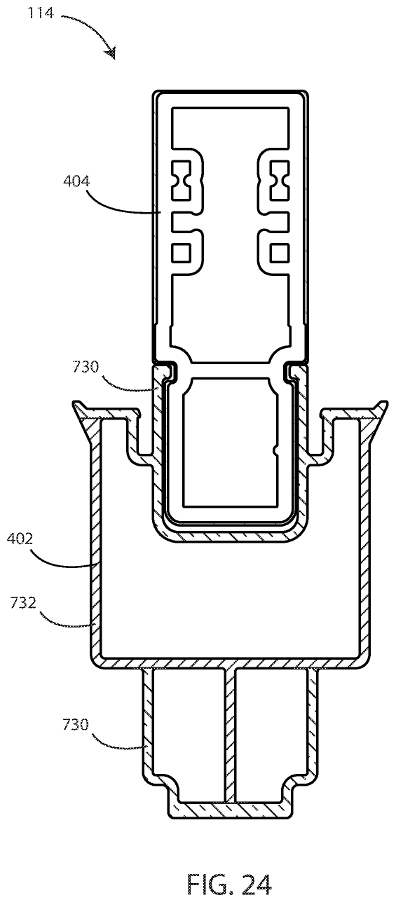

Referring now to FIG. 23, a cross-sectional view of a mull post 114 is shown in accordance with various embodiments herein. In the example of FIG. 23, the outside piece 402 and the inside piece 404 are physically integrated as a unitary whole. The mull post 114 includes portions formed of first composition 730 and portions formed of second composition 732.

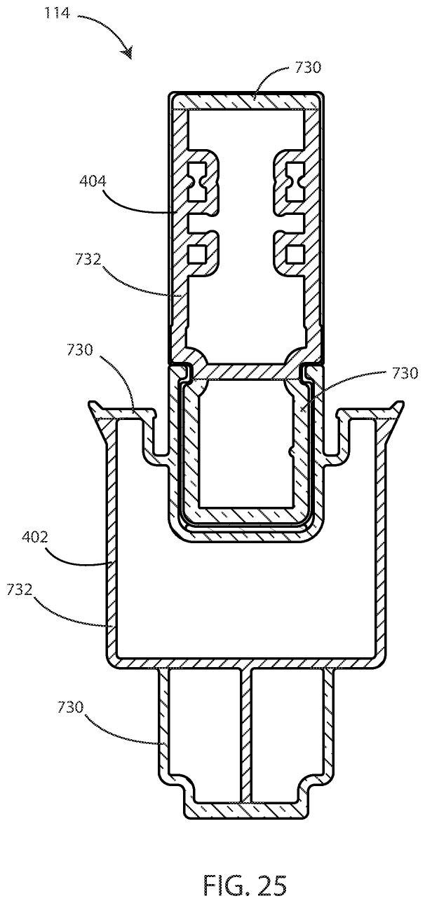

Referring now to FIG. 24, a cross-sectional view of a mull post 114 is shown in accordance with various embodiments herein. The mull post 114 includes an outside piece 402 and an inside piece 404. In this embodiment, the outside piece 402 includes portions formed of first composition 730 and portions formed of second composition 732. The inside piece 404 can be formed of the same materials or different materials. In some embodiments, the inside piece 404 can be a pultrusion.

Referring now to FIG. 25, a cross-sectional view of a mull post 114 is shown in accordance with various embodiments herein. The mull post 114 includes an outside piece 402 and an inside piece 404. In this embodiment, the outside piece 402 includes portions formed of first composition 730 and portions formed of second composition 732. Similarly, the inside piece 404 includes portions formed of first composition 730 and portions formed of second composition 732. In this embodiments, the inside piece 404 (including the first composition 730 and the second composition 732) fits at least partially within the outside piece 402 (also including the first composition 730 and the second composition 732).

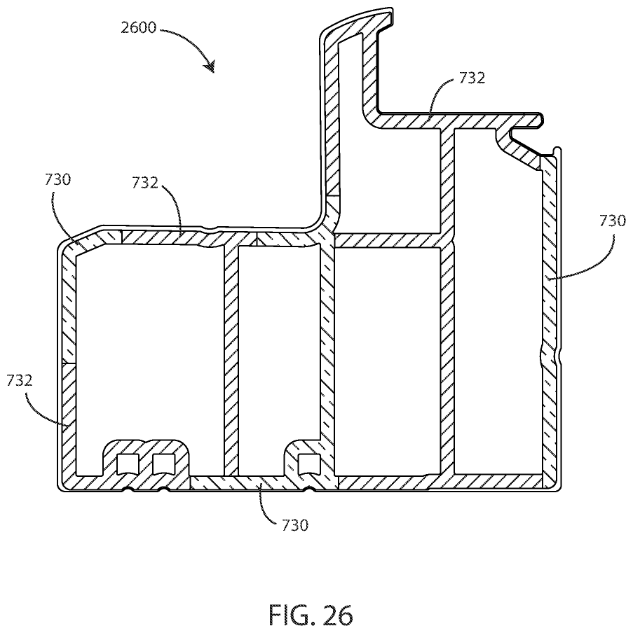

It will be appreciated that in accordance with various embodiments herein that lineal structural members can include a plurality of different segments. By way of example, lineal structural members herein can include one, two, three, four five, six, or more different segments. Referring now to FIG. 26, a cross-sectional view of a lineal structural member 2600 is shown in accordance with various embodiments herein. The lineal structural member 2600 can include portions formed of first composition 730 and portions formed of second composition 732. In this case, there are six different segments, with three formed of the first composition 730 and three formed of the second composition 732.

Compositions Various embodiments herein can be formed with compositions including various components. Further details exemplary compositions and components thereof are provided as follows. However, it will be appreciated that this is merely provided by way of example and that further variations are contemplated herein.

Compositions herein can include one or more polymer resins. Exemplary polymers for the resin component are described in greater detail below. In many cases, the resin component can be mixed with other components (such as fibers, particles, and the like described in greater detail below). However, in some embodiments, a composition herein can be a neat polymer composition (other than processing aids). For example, in some embodiments, a composition herein (such as a second composition) can be a neat PVC composition (e.g., a composition lacking fibers and particulates).

### Polymer Resin

As used herein, the term “resin” shall refer to the thermoplastic polymer content of the extruded or pultruded composition. The resin portion of the composition excludes any polymer content provided by processing aids.

Polymer resins used with embodiments herein (including “first compositions” and/or “second compositions” herein) can include various types of polymers including, but not limited to, addition polymers, condensation polymers, natural polymers, treated polymers, and thermoplastic resins.

Thermoplastic resins herein can include addition polymers including poly alpha-olefins, polyethylene, polypropylene, poly 4-methyl-pentene-1, ethylene/vinyl copolymers, ethylene vinyl acetate copolymers, ethylene acrylic acid copolymers, ethylene methacrylate copolymers, ethyl-methylacrylate copolymers, etc.; thermoplastic propylene polymers such as polypropylene, ethylene-propylene copolymers, etc.; vinyl chloride polymers and copolymers; vinylidene chloride polymers and copolymers; polyvinyl alcohols, acrylic polymers made from acrylic acid, methacrylic acid, methylacrylate, methacrylate, acrylamide and others. Fluorocarbon resins such as polytetrafluoroethylene, polyvinylidiene fluoride, and fluorinated ethylene-propylene resins. Styrene resins such as a polystyrene, alpha-methylstyrene, high impact polystyrene acrylonitrile-butadiene-styrene polymers.

A variety of condensation polymers can also be used in the manufacture of the composites herein including nylon (polyamide) resins such as nylon 6, nylon 66, nylon 10, nylon 11, nylon 12, etc. A variety of polyester materials can be made from dibasic aliphatic and aromatic carboxylic acids and di- or triols. Representative examples include polyethylene-terephthlate, polybutylene terephthlate and others.

Polycarbonates can also be used in the polymeric resin. Such polycarbonates are long chained linear polyesters of carbonic acid and dihydric phenols typically made by reacting phosgene (COCl₂) with bisphenol A resulting in transparent, tough, dimensionally stable plastics. A variety of other condensation polymers are used including polyetherimide, polysulfone, polyethersulfone, polybenzazoles, aromatic polysulfones, polyphenylene oxides, polyether ether ketone, and others.

Poly(vinyl chloride) can be used as a homopolymer, but can also be combined with other vinyl monomers in the manufacture of polyvinyl chloride copolymers. Such copolymers can be linear copolymers, branched copolymers, graft copolymers, random copolymers, regular repeating copolymers, block copolymers, etc. Monomers that can be combined with vinyl chloride to form vinyl chloride copolymers include a acrylonitrile; alpha-olefins such as ethylene, propylene, etc.; chlorinated monomers such as vinylidene chloride, chlorinated polyethylene, acrylate monomers such as acrylic acid, methylacrylate, methylmethacrylate, acrylamide, hydroxyethyl acrylate, and others; styrenic monomers such as styrene, alphamethyl styrene, vinyl toluene, etc.; vinyl acetate; and other commonly available ethylenically unsaturated monomer compositions. Poly(vinyl chloride) compounds herein can specifically include chlorinated polyvinylchloride (cPVC).

In some embodiments, poly(vinyl chloride) polymers having an average molecular weight (Mn) of about 40,000 to about 140,000 (90,000+/−50,000) can be used. In some embodiments, poly(vinyl chloride) polymers having an average molecular weight (Mn) of about 78,000 to about 98,000 (88,000+/−10,000) can be used.

In some embodiments, poly(vinyl chloride) polymers used herein can have an inherent viscosity (IV-ASTM D-5225) of about 0.68 to about 1.09. In some embodiments, poly(vinyl chloride) polymers used herein can have an inherent viscosity of about 0.88 to about 0.92.

In some embodiments, poly(vinyl chloride) polymers used herein can have a glass transition temperature (Tg) of about 70 to about 80 degrees.

Poly(vinyl chloride) polymers are available from many sources under various tradenames including, but not limited to, Oxy Vinyl, Vista 5385 Resin, Shintech SE-950EG and Oxy Vinyl 225G, among others.

In some embodiments, polypropylene having a melt flow rate (g/10 min) (ASTM D1238, 230C) of 0.5 to 75.0 can be used. In some embodiments, polypropylene having a glass transition temperature (Tg) of about 0 to about 20 degrees Celsius can be used.

In some embodiments, polyethylene terephthalate (PET) having an intrinsic viscosity (IV) (DI/g) of about 0.76 to about 0.9 can be used. In some embodiments, polyethylene terephthalate (PET) having a glass transition temperature (Tg) of about 70 to about 80 degrees Celsius can be used. In some embodiments, glycol modified polyethylene terephthalate (PETG) having a glass transition temperature (Tg) of about 78-82 degrees Celsius can be used.

In some embodiments, polybutylene terephthalate (PBT) having a melt flow rate (g/10 min) (ASTM D1238, 1.2 kg, 250 C) of 100 to 130 can be used. In some embodiments, polybutylene terephthalate (PBT) having a glass transition temperature (Tg) of about 45 to about 85 degrees Celsius can be used.

Polymer blends or polymer alloys can be used herein. Such alloys can include two miscible polymers blended to form a uniform composition. A polymer alloy at equilibrium comprises a mixture of two amorphous polymers existing as a single phase of intimately mixed segments of the two macro molecular components. Miscible amorphous polymers can form glasses upon sufficient cooling and a homogeneous or miscible polymer blend can exhibit a single, composition dependent glass transition temperature (Tg). An immiscible or non-alloyed blend of polymers typically displays two or more glass transition temperatures associated with immiscible polymer phases.

Polymeric resin materials herein can retain sufficient thermoplastic properties to permit melt blending with fiber, to permit formation of extruded articles or other extrudates such as pellets, and to permit the composition material or pellet to be extruded in a thermoplastic process or in conjunction with a pultrusion process.

In some embodiments, polymer resins herein can include extrusion grade polymer resins. In some embodiments, polymer resins herein can include resins other than extrusion grade polymer resins, including, but not limited to, injection molding grade resins. Polymer resins used herein can include non-degradable polymers. Non-degradable polymers can include those that lack hydrolytically labile bonds (such as esters, orthoesters, anhydrides and amides) within the polymeric backbone. Non-degradable polymers can also include those for which degradation is not mediated at least partially by a biological system. In some embodiments, polymers that are otherwise degradable can be made to be non-degradable through the use of stabilizing agents that prevent substantial break down of the polymeric backbone.

Polymer resins herein can include those derived from renewable resources as well as those derived from non-renewable resources. Polymers derived from petroleum are generally considered to be derived from non-renewable resources. However, polymers that can be derived from biomass are generally considered to be derived from renewable resources. Polymer resins can specifically include polyesters (or biopolyesters) derived from renewable resources, including, but not limited to polyhydroxybutyrate, polylactic acid (PLA or polylactide), and the like. Such polymers can be used as homopolymer and/or copolymers including the same as subunits. Polymer resins herein can specifically include extrusion grade polymers.

PLA can be amorphous or crystalline. In certain embodiments, the PLA is a substantially homopolymeric polylactic acid. Such a substantially homopolymeric PLA promotes crystallization. Since lactic acid is a chiral compound, PLA can exist either as PLA-L or PLA-D. As used herein, the term homopolymeric PLA refers to either PLA-L or PLA-D, wherein the monomeric units making up each polymer are all of substantially the same chirality, either L or D. Typically, polymerization of a racemic mixture of L- and D-lactides usually leads to the synthesis of poly-DL-lactide (PDLLA), which is amorphous. In some instances, PLA-L and PLA-D will, when combined, co-crystallize to form stereoisomers, provided that the PLA-L and PLA-D are each substantially homopolymeric, and that, as used herein, PLA containing such stereoisomers is also to be considered homopolymeric. Use of stereospecific catalysts can lead to heterotactic PLA, which has been found to show crystallinity. The degree of crystallinity can be influenced by the ratio of D to L enantiomers used (in particular, greater amount of L relative to D in a PLA material is desired), and to a lesser extent on the type of catalyst used. There are commercially available PLA resins that include, for example, 1-10% D and 90-99% L. Further information about PLA can be found in the book Poly(Lactic Acid) Synthesis, Structures, Properties, Processing, and Applications, Wiley Series on Polymer Engineering and Technology (Rafael Auras et al. eds., 2010).

In some embodiments, polylactic acid polymers having number average molecular weights of about 50,000 to 111,000, or weight average molecular weights (Mw) ranging from 100,000 to 210,000, and polydispersity indices (PDI) of 1.9-2 can be used.

In some embodiments, polylactic acid polymers having a melt flow rate (g/10 min) (ASTM D1238, 210 C 2.16 kg) of about 5.0 to about 85 can be used. In some embodiments, polylactic acid polymers having a glass transition temperature (Tg) of about 45 to about 65 degrees Celsius can be used. In some embodiments, polylactic acid polymers having a glass transition temperature (Tg) of about 55 to about 75 degrees Celsius can be used.

Polymers of the polymer resin used herein can have various glass transition temperatures, but in some embodiments glass transition temperatures of at least 120, 130, 140, 150, 160, 170, 180, 190, 200, 220, 240, 260, 280, 300, 320, 340, 360, 380 or 400 degrees fahrenheit. In some embodiments, polymers having a glass transition temperature of from about 140° F. to about 220° F. can be used.

The polymer resin can make up the largest share of the extruded composition. In some embodiments, the polymer resin is at least about 20, 25, 30, 35, 40, 45, 50, 55, 60, 65, 70, 75, 80, 85, 90, 95, 98, or 99 wt. % of the extruded composition. In some embodiments, the amount of the polymer resin in the composition can be in a range wherein any of the foregoing numbers can serve as the upper or lower bound of the range, provided that the upper bound is larger than the lower bound.

### Fibers

Various compositions here can include some amount of fibers. By way of example, a first composition herein can include an amount of fibers. In some embodiments, a second composition herein can also include some amount of fibers, but in other embodiments may lack fiber content. Descriptions herein of exemplary fibers are only applicable for the description of embodiments herein and not for other patents or patent applications of the applicant and/or inventors unless explicitly stated to the contrary. Various embodiments of compositions and extrudates herein include a fiber component.

Fibers used herein can include fibers of various types and in various amounts. Exemplary fibers can include cellulosic and/or lignocellulosic fibers. By way of example, fibers used in embodiments herein can include materials such as glasses, polymers, ceramics, metals, carbon, basalt, composites, or the like, and combinations of these. Exemplary glasses for use as fibers can include, but are not limited to, silicate fibers and, in particular, silica glasses, borosilicate glasses, alumino-silicate glasses, alumino-borosilicate glasses and the like. Exemplary glass fibers can also include those made from A-glass, AR-glass, D-glass, E-glass with boron, E-glass without boron, ECR glass, S-glass, T-glass, R-glass, and variants of all of these. Exemplary glass fibers include 415A-14C glass fibers, commercially available from Owens Corning.

Exemplary polymers for use as fibers can include, but are not limited to, both natural and synthetic polymers. Polymers for fibers can include thermosets as well as thermoplastics with relatively high melt temperatures, such as 210 degrees Celsius or higher.

Natural fibers that can be used in the invention include fibers derived from jute, flax, bamboo, hemp, ramie, cotton, kapok, coconut, palm leaf, sisal, and others.

Synthetic fibers that can be used in the manufacture of the composites herein include cellulose acetate, acrylic fibers such as acrylonitrile, methylmethacrylate fibers, methylacrylate fibers, and a variety of other basic acrylic materials including homopolymers and copolymers of a variety of acrylic monomers, aramid fibers which comprise polyamides having about 85% or more of amide linkages directly attached to two aromatic rings, nylon fibers, polyvinylidene dinitryl polymers. Polyester including polyethylene terephthlate, polybutylene terephthlate, polyethylene naphthalate, RAYON, polyvinylidene chloride, spandex materials such as known segmented polyurethane thermoplastic elastomers, vinyl alcohol, and modified polyvinyl alcohol polymers and others.

Fibers used herein can include newly synthesized or virgin materials as well as recycled materials or portions of recycled materials.

In some embodiments, the material of the fibers can be organic in nature. In other embodiments, the material of the fibers can be inorganic in nature. Fibers can be carbon fibers, basalt fibers, cellulosic fibers, ligno-cellulosic fibers, silicate fibers, boron fibers, and the like. Exemplary metal fibers that can be used herein can include steel, stainless steel, aluminum, titanium, copper and others.

Fibers used herein can have various tensile strengths. Tensile strength can be measured in various ways, such as in accordance with ASTM D2101. In some embodiments, the tensile strength of fibers used herein can be greater than or equal to about 1000, 1500, 2000, 2500, or 3000 MPa. In some embodiments, the tensile strength of fibers herein can be less than about 5000 MPa.

Fibers herein can include those having various dimensions. Fibers used herein can have an average diameter greater than or equal to about 1, 2, 3, 4, 5, 10, 15, 20, 25, 30, 35, 40, 45, 50, 100, 200, 300, or 500 microns. In some embodiments, fibers used herein can have an average diameter of less than or equal to about 1000, 900, 800, 700, 600, 500, 400, 300, 200, 100, or 50 microns. In various embodiments, the average diameter of fibers used herein can be in a range wherein any of the foregoing diameters can serve as the upper or lower bound of the range, provided that the upper bound is greater than the lower bound. In some embodiments, the average diameter of the fibers used herein can be from 2 microns to 50 microns. In some embodiments, the average diameter of the fibers used herein can be from 10 microns to 20 microns.

Fibers used herein can have an average length of greater than or equal to about 0.1, 0.2, 0.4, 0.6, 0.8, 1, 2, 3, 4, 6, 8, 10, 12, 14, 16, 18, 20, 30, 40, 50, or 100 millimeters in length. In some embodiments, fibers used herein can have an average length of less than or equal to about 150, 100, 90, 80, 70, 60, 50, 40, 30 20, 10, 8, 5, 4, 3, or 2 millimeters. In various embodiments, the average length of fibers used herein can be in a range where any of the foregoing lengths can serve as the upper or lower bound of the range, provided that the upper bound is greater than the lower bound. In some embodiments, the average lengths of the fibers used herein can be from 0.2 millimeters to 10 millimeters. In some embodiments, the average lengths of the fibers used herein can be from 2 millimeters to 8 millimeters. It will be appreciated that fiber breakage typically occurs as a result of shear forces within the extruder. Therefore, the foregoing lengths can be as measured prior to compounding and/or extruding steps or after compounding and/or extruding steps such as in the finished extrudate.

Fibers herein can also be characterized by their aspect ratio, wherein the aspect ratio is the ratio of the length to the diameter. In some embodiments, fibers herein can include those having an aspect ratio of about 10,000:1 to about 1:1. In some embodiments, fibers herein can include those having an aspect ratio of about 5,000:1 to about 1:1. In some embodiments, fibers herein can include those having an aspect ratio of about 600:1 to about 2:1. In some embodiments, fibers herein can include those having an aspect ratio of about 500:1 to about 4:1. In some embodiments, fibers herein can include those having an aspect ratio of about 400:1 to about 15:1. In some embodiments, fibers herein can include those having an aspect ratio of about 350:1 to about 25:1. In some embodiments, fibers herein can include those having an aspect ratio of about 300:1 to about 50:1.

It will be appreciated that in many embodiments not every fiber used will be identical in its dimensions and, as such, the foregoing dimensions can refer to the average (mean) of the fibers that are used.

It will be appreciated that the dimensions of fibers can change during processing steps associated with the creation of extruded articles including, but not limited to, steps of compounding and/or extruding. As such, in some embodiments the foregoing measures of aspect ratio, length, and diameter can be as measured before such processing steps or as measured after such processing steps.

In some embodiments, the fibers used herein can include a single fiber type in terms of material and dimensions and in other embodiments can include a mixture of different fiber types and/or fiber dimensions. In some embodiments, the fibers used herein can include a first fiber type and/or size in combination with a second fiber type and/or size.

In various embodiments, fibers used herein can be coated with a material. By way of example, fibers can be coated with a lubricant, a tie layer, or other type of compound.

The amount of the fibers used in a composition (such as a first composition) can vary based on the application. In some embodiments, the amount of fibers in the composition can be greater than or equal to about 1, 2, 4, 6, 8, 10, 15, 20, 25, 30, 40, 50, 60, 70, or even 80 wt. % (calculated based on the weight of the fibers as a percent of the total weight of the extruded composition in which the fibers are disposed). In some embodiments, the amount of fibers in extruded composition can be less than or equal to about 90, 80, 75, 70, 65, 60, 55, 50, 45, 40, 35, 30, 25, 20, or 15 weight percent. In some embodiments, the amount of fibers in the extruded composition (first and/or second compositions) can be in a range wherein each of the foregoing numbers can serve as the upper or lower bounds of the range provided that the upper bound is larger than the lower bound.

### Particles

Descriptions herein of exemplary particles are only applicable for the description of embodiments herein and not for other patents or patent applications of the applicant and/or inventors unless explicitly stated to the contrary.

Some compositions herein can include an amount of particles. Particles can include both organic and inorganic particles. Such particles can be roughly spherical, semi-spherical, block-like, flat, needle-like (acicular), plate-like (platy), flake-like (flaky), or other shape forms. Particles herein can have substantial variation. As such, the particles added to compositions in some embodiments can form a heterogeneous mixture of particles. In other embodiments, the particles can be substantially homogeneous.

In some embodiments, the particles used with compositions herein can have an aspect ratio of between about 15:1 and about 1:1. In some embodiments, particles herein can have an aspect ratio of between about 10:1 and about 1:1. In some embodiments, particles herein can have an aspect ratio of between about 8:1 and about 1:1. In some embodiments, particles herein can have an aspect ratio of between about 7:1 and about 1:1. In some embodiments, particles herein can have an aspect ratio of between about 6:1 and about 1:1. In some embodiments, particles herein can have an aspect ratio of between about 5:1 and about 1:1. In some embodiments, particles herein can have an aspect ratio of between about 4:1 and about 1:1. In some embodiments, particles herein can have an aspect ratio of between about 3:1 and about 1:1. In some embodiments, particles herein can have an aspect ratio of between about 2:1 and about 1:1. Such aspect ratios can be assessed by first taking the largest dimension of the particle (major axis) and then comparing it with the next largest dimension of the particle that is perpendicular to the major axis.

In various embodiments, the particles can be, on average, from about 0.01 mm to about 8 mm in their largest dimension (or major axis or characteristic dimension). In various embodiments, the particles can be from about 0.25 mm to about 5 mm in their largest dimension. In various embodiments, the particles can have an average size of about 0.1 mm to about 2.5 mm in their largest dimension. In various embodiments, the particles can have an average size of about 0.18 mm to about 0.6 mm in their largest dimension. In various embodiments, the particles can have an average size of greater than about 0.6 mm in their largest dimension. For example, in various embodiments, the particles can have an average size of about 0.6 mm to about 3.0 mm in their largest dimension. In various embodiments, the particles can have an average size of about 0.5 mm to about 2.5 mm in their largest dimension. In various embodiments, the particles can have an average size of about 1 mm to about 2 mm in their largest dimension.

In some embodiments, the particles can have an average size of their largest dimension falling within a range wherein the lower bound and the upper bound can be any of the following sizes (provided that the upper bound is greater than the lower bound): 0.01 mm, 0.02 mm, 0.03 mm, 0.05 mm, 0.07 mm, 0.09 mm, 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.2 mm, 2.4 mm, 2.6 mm, 2.8 mm, 3.0 mm, 3.5 mm, 4.0 mm, 4.5 mm, 5.0 mm, 5.5 mm, 6.0 mm, 6.5 mm, 7.0 mm, and 8.0 mm.

In some embodiments, the particles are organic particles and can have an average size of their largest dimension falling within a range wherein the lower bound and the upper bound can be any of the following sizes (provided that the upper bound is greater than the lower bound): 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.2 mm, 2.4 mm, 2.6 mm, 2.8 mm, and 3.0 mm.

In some embodiments, the particles are inorganic particles and can have an average size of their largest dimension falling within a range wherein the lower bound and the upper bound can be any of the following sizes (provided that the upper bound is greater than the lower bound): 0.01 mm, 0.02 mm, 0.03 mm, 0.05 mm, 0.07 mm, 0.09 mm, 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.2 mm, 2.4 mm, 2.6 mm, 2.8 mm, and 3.0 mm.

As referenced above, aspect ratios can be assessed by first taking the largest dimension of the particle (major axis) and then comparing it with the next largest dimension of the particle along an axis (Y axis) that is perpendicular to the major axis (X axis). The depth or Z axis measure (Z axis) can be measured along an axis that is perpendicular to both the X and Y axes used to specify the aspect ratio. In some embodiments, particles herein can have an average or maximum depth or Z axis measure in the context of the aspect ratios described above that is equal to at least about 0.1, 0.2, 0.3, 0.4, 0.5, 0.6, 0.7, 0.8, 0.9, or 0.95 of the smaller of the two dimensions used to assess aspect ratio.

It will be appreciated that the dimensions of particles can change during processing steps associated with the creation of extruded articles including, but not limited to, steps of compounding and/or extruding. As such, in some embodiments the foregoing measures of aspect ratio and size can be as measured before such processing steps or as measured after such processing steps.

It will be appreciated that in many embodiments not every particle used will be identical in its dimensions and, as such, the foregoing dimensions can refer to the average (mean) of the particles that are used.

Particles herein can include materials such as polymers, carbon, organic materials, inorganic materials, composites, or the like, and combinations of these. Polymers for the particles can include both thermoset and thermoplastic polymers. Inorganic particle materials can include, but are not limited to silicates. Inorganic particle materials can specifically include, but are not limited to, glass beads, glass bubbles, minerals such as mica and talc, and the like.

Particles herein can specifically include organic particles. Particles herein can specifically include particles comprising substantial portions of lignin, hemicellulose and cellulose (lignocellulosic materials), such as wood particles or wood flour. Wood particles can be derived from hardwoods or softwoods. In various embodiments, the wood particles can have a moisture content of less than about 8, 6, 4, or 2 percent.

Particle sizes and distributions thereof can be described using sieve sizes. Standard U.S. sieve sizes and Tyler mesh sizes are shown in Table 3 below with the corresponding opening size.

TABLE 3

| U.S. Sieve Size | Tyler Mesh Size | Opening (mm) |
|---|---|---|
| 10 | 9 | 2.00 |
| 12 | 10 | 1.68 |
| 14 | 12 | 1.41 |
| 16 | 14 | 1.19 |
| 18 | 16 | 1.00 |
| 20 | 20 | 0.841 |
| 25 | 24 | 0.707 |
| 30 | 28 | 0.595 |
| 35 | 32 | 0.500 |
| 40 | 35 | 0.420 |
| 45 | 42 | 0.354 |
| 50 | 48 | 0.297 |
| 60 | 60 | 0.250 |
| 70 | 65 | 0.210 |
| 80 | 80 | 0.177 |
| 100 | 100 | 0.149 |
| 120 | 115 | 0.125 |

In various embodiments, the wood particles can be a heterogeneous mixture of wood particles, wherein at least about 50, 60, 70, 80, 90, or 95 weight percent of the particles are 80 Mesh or larger (or 80 sieve size-corresponding to a pore size of 0.177 mm and a particle size of approximately 0.180 mm).

In various embodiments, the wood particles can be a heterogeneous mixture of wood particles, wherein at least about 50, 60, 70, 80, 90, or 95 weight percent of the particles are 80 Mesh or larger (or 80 sieve size-corresponding to a pore size of 0.177 mm and a particle size of approximately 0.180 mm) and less than 9 Mesh (or 10 sieve size-corresponding to a pore size of 2.00 mm).

In various embodiments, the wood particles can be a heterogeneous mixture of wood particles, wherein at least about 50, 60, 70, 80, 90, or 95 weight percent of the particles are 28 Mesh or larger (or 30 sieve size-corresponding to a pore size of 0.595 mm and a particle size of approximately 0.6 mm).

In various embodiments, the wood particles can be a heterogeneous mixture of wood particles, wherein at least about 50, 60, 70, 80, 90, or 95 weight percent of the particles are 28 Mesh or larger (or 30 sieve size-corresponding to a pore size of 0.595 mm and a particle size of approximately 0.6 mm) and less than 9 Mesh (or 10 sieve size-corresponding to a pore size of 2.00 mm).

Other biomaterials or other organic materials may also be used as particles. As used herein, the term “biomaterial” will refer to materials of biological origin, such as wood fiber, hemp, kenaf, bamboo, rice hulls, and nutshells. More generally, other lignocellulose materials resulting from agricultural crops and their residues may also be used as particles.

In some embodiments, particles herein can include inorganic materials such as metal oxide particles or spheres, glass particles, or other like materials. These particles may be used either alone or in combination with other organic or inorganic particles.

Particles used herein can include newly synthesized or virgin materials as well as recycled or reclaimed materials or portions of recycled materials. In some embodiments, reclaim streams can be from the composition herein or from other extrusion, molding, or pultrusion compositions. As such, in some embodiments particles herein can include portions of multiple materials.

In various embodiments, the particles can be substantially uniformly dispersed within a given extruded composition.

In some embodiments, the particles used herein can include a single particle type in terms of material and dimensions, and in other embodiments can include a mixture of different particle types and/or fiber dimensions. In some embodiments, the particles used herein can include a first particle type and/or size in combination with a second particle type and/or size.

In various embodiments, particles used herein can be coated with a material. By way of example, particles can be coated with a lubricant, a tie layer, or other type of compound.

The amount of the particles used in the composition can vary based on the application. In some embodiments, the amount of particles in the composition can be greater than or equal to about 1, 2, 4, 6, 8, 10, 15, 20, 25, or 30 wt. % (calculated based on the weight of the particles as a percent of the total weight of the extruded composition in which the particles are disposed). In some embodiments, the amount of particles in the composition can be less than or equal to about 80, 75, 70, 65, 60, 55, 50, 45, 40, 35, 30, 25, 20, 15, 10, or 5 weight percent. In some embodiments, the amount of particles (in the first and/or second composition) can be in a range wherein each of the foregoing numbers and serve as the upper or lower bound of the range provided that the upper bound is larger than the lower bound.

The amount of particles in the extruded composition, as measured based on volume, can be greater than or equal to about 1, 2, 3, 4, 5, 6, 7, 8, 9, 10, 12, 14, 16, 18, 20, 22, 24, 26, 28, 30, 32, 34, or 36 percent of the total composition. In some embodiments, the amount of particles as measured based on volume can be in a range wherein any of the foregoing amounts can serve as the upper or lower bound of the range.

It will be appreciated that in some embodiments, some amount of out of specification particles can also be included. As such, in some embodiments, at least 50, 60, 70, 80, 90, 95, or 98 wt. % of the total particle content of the composition are those such the particles described above. For example, in some embodiments at least 50 wt. % of the particles are selected from the group consisting of organic particles having an average largest dimension of greater than 100 microns and an aspect ratio of 4:1 or less and inorganic particles having an average largest dimension of greater than 10 microns and an aspect ratio of 4:1 or less.

### Impact Modifiers

In some embodiments, some composition herein can include impact modifiers. Impact modifiers can include acrylic impact modifiers. Acrylic impact modifiers can include traditional type acrylic modifiers as well as core-shell type impact modifiers. Exemplary acrylic impact modifiers can include those sold under the tradename DURASTRENGTH, commercially available from Arkema, and PARALOID (including, specifically, KM-X100) commercially available from Dow Chemical.

Impact modifiers can also include various copolymers including, but not limited to, ethylene-vinyl acetate (EVA), acrylonitrile-butadiene-styrene (ABS), methacrylate butadiene styrene (MBS), chlorinated polyethylene (CPE), ethylene-vinyl acetate-carbon monoxide, or ethylene-n-butyl acrylate-carbon monoxide. Exemplary impact modifier copolymers can include those sold under the tradename ELVALOY, commercially available from DuPont.

The amount of impact modifier used can vary in different embodiments. One approach to quantifying the amount of impact modifier used can be with reference to the amount of polymer resin used. As is common in the extrusion art, this type of quantification can be stated as the parts by weight of the component in question per hundred parts by weight of the polymer resin. This can be referred to as “parts per hundred resin” or “phr”.

In some embodiments, the composition can include an amount of impact modifier of greater than or equal to 0.1 phr, 0.5 phr, 1 phr, 2 phr, 3 phr, 4 phr, 5 phr, 6 phr, 7 phr, 8 phr, 10 phr, 12.5 phr, 15 phr, or 20 phr. In some embodiments, the composition can include an amount of impact modifier of less than or equal to 40 phr, 35 phr, 30 phr, 27.5 phr, 25 phr, 22.5 phr, 20 phr, 17.5 phr, or 15 phr. In some embodiments, the composition can include an amount of impact modifier in a range wherein any of the foregoing numbers can serve as the lower or upper bounds of the range provided that the lower bound is less than the upper bound.

By way of example, in some embodiments, the composition can include an amount of impact modifier of greater than or equal to 0.1 phr and less than or equal to 40 phr. In some embodiments, the composition can include an amount of impact modifier of greater than or equal to 1.0 phr and less than or equal to 30 phr. In some embodiments, the composition can include an amount of impact modifier of greater than or equal to 1.0 phr and less than or equal to 30 phr. In some embodiments, the composition can include an amount of impact modifier of greater than or equal to 2.0 phr and less than or equal to 25 phr. In some embodiments, the composition can include an amount of impact modifier of greater than or equal to 3.0 phr and less than or equal to 25 phr. In some embodiments, the composition can include an amount of impact modifier of greater than or equal to 4.0 phr and less than or equal to 25 phr.

In some embodiments, the composition can include an amount of impact modifier of greater than or equal to 5 phr and less than or equal to 25 phr. In some embodiments, the composition can include an amount of impact modifier of greater than or equal to 6 phr and less than or equal to 20 phr. In some embodiments, the composition can include an amount of impact modifier of greater than or equal to 7 phr and less than or equal to 20 phr. In some embodiments, the composition can include an amount of impact modifier of greater than or equal to 5 phr and less than or equal to 20 phr. In some embodiments, the composition can include an amount of impact modifier of greater than or equal to 10 phr and less than or equal to 20 phr.

### Other Components

It will be appreciated that various other components can be extruded with compositions herein (first or second compositions) and in some cases can form part of compositions herein. By way of example, process aids can be included in various embodiments.

Examples of process aids include acrylic processing aids, waxes, such as paraffin wax, stearates, such as calcium stearate and glycerol monostearate, and polymeric materials, such as oxidized polyethylene. Various types of stabilizers can also be included herein such as UV stabilizers, lead, tin and mixed metal stabilizers, and the like. It is contemplated that there may be examples wherein satisfactory results may be obtained without one or more of the disclosed additives. Exemplary processing aids can include a process aid that acts as a metal release agent and possible stabilizer available under the trade designation XL-623 (paraffin, montan and fatty acid ester wax mixture) from Amerilubes, LLC of Charlotte, N.C. Calcium stearate is another suitable processing aid that can be used as a lubricant. Typical amounts for such processing aids can range from 0 to 20 wt. % based on the total weight of the composition, depending on the melt characteristics of the formulation that is desired. In some embodiments, the amount of processing aids is from 2 to 14 wt. %. In some embodiments, the amount of processing aids (as measured in parts per hundred resin) can range from 0 to 40 phr, 0.5 to 30 phr, or 0.5 to 20 phr.

Examples of other components that can be included are calcium carbonate, titanium dioxide, pigments, and the like.

### Methods

Methods herein can include various procedures. By way of example, methods can include one or more of mixing, compounding, gas removal, moisture removal, and final extrusion. Materials can be mixed using a variety of mixing means, including extruder mechanisms wherein the materials are mixed under conditions of high shear until the appropriate degree of wetting and intimate contact is achieved. In some embodiments, the moisture content can be controlled at a moisture removal station. By way of example, the heated composite is exposed to atmospheric pressure or reduced pressure at elevated temperature for a sufficient period of time to remove moisture, resulting in a final desired moisture content. In some embodiments, the final moisture content is about 8 wt. % or less.

As used herein, the term “compounding” refers to the process of combining a polymeric material with at least one other ingredient, either polymeric or non-polymeric, at a temperature sufficiently elevated to allow the ingredients to be mixed into a molten mass.

In some cases, inputs are fed directly, without a compounding step, into an extruder (including but not limited to single screw, double screw, co-rotating, counter-rotating, conical, parallel or the like) that produces the final product, such as an extruded article. In other cases, the inputs can first be processed with a compounding extrusion step, wherein the inputs are mixed together and run through a compounding extruder which provides for high levels of mixing and interaction of components. While various extruders can be used for compounding, typically twin-screw extruders are used in either co-rotating or counter-rotating configurations. In some embodiments, a compounding operation can be referred to as a pelletizing operation, because the output from the compounding operation is typically pellets.

The articles herein can be formed by known extrusion (including co-extrusion) techniques, pultrusion techniques, and the like. At its most basic level, extrusion is the process of producing continuous articles by forcing a material through a die. The extruded article can be of various shapes depending on the extrusion die geometry. In polymer extrusion, the material being forced through a die is a molten polymer.

Profile extrusion refers to the process of making continuous shapes by extrusion. The term “profile extrusion” also refers to the resultant extruded article formed during the profile extrusion process. In certain embodiments, the article, which is particularly in the form of a building component, is in the form of a profile extrusion or extruded article. In some embodiments, profile extrusion can exclude the formation of sheets.

In addition, a process called co-extrusion can be used herein. Co-extrusion refers to a process whereby two or more polymeric materials, each extruded separately, are joined in a molten state in the die. In some applications, the co-extruded surface layer can be referred to as a capping layer or capstock. In some embodiments, compositions herein can be extruded in the form of a capping layer over non-thermoplastic materials such as wood, thermosets, or metal.

In some embodiments, compositions herein can be extruded in particular wall segments (internal or external) such that the placement provides reinforced strength or other benefits identified through Finite Element Analysis (FEA). By way of example, the composite material herein can be used in applications wherein the desirable strength is known through FEA modeling and applied only in those specific areas to enhance lineal performance or extruded specifically in a particular lineal within a unit assembly to enhance unit performance.

The articles herein can be in the form of a profile that has been formed by an extrusion process (referred to herein as a “profile extrusion”), including, in some embodiments, a co-extruded layer or capping material (e.g., over another material such as a wood window or door component). The articles herein can be in the form of an extruded article, a pultruded article, or a combination thereof.

One exemplary piece of equipment for mixing and extruding the compositions herein is an industrial extruder device. Such extruders can be obtained from a variety of manufacturers.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1-35. (canceled)

36. A fenestration assembly comprising:
a sash or a frame, the sash or a frame comprising
a first lineal member;
a second lineal member;
a third lineal member, wherein the third lineal member is connected to the second lineal member and the first lineal member; and
a fourth lineal member, wherein the fourth lineal member is connected to the second lineal member and the first lineal member;
wherein at least one of the first lineal member, the second lineal member, the third lineal member, and the fourth lineal member comprise a first lineal extrusion at least partially formed with a first composition;
the first composition comprising
at least 5 wt. % fibers; and
a first polymer resin;
wherein at least one of the first lineal member, the second lineal member, the third lineal member, and the fourth lineal member comprise a second lineal extrusion at least partially formed with a second composition; and
the second composition comprising a second polymer resin.

37. The fenestration assembly of claim 36, the at least 5 wt. % fibers comprising glass fibers.

38. The fenestration assembly of claim 36, the first composition further comprising at least 10 wt. % glass fibers.

39. The fenestration assembly of claim 36, the first composition further comprising at least 30 wt. % glass fibers.

40-52. (canceled)

53. A fenestration assembly comprising:
a lineal extrusion, wherein the lineal extrusion defines one or more interior hollows, the lineal extrusion comprising
an interior portion, wherein the interior portion is adjacent an interior side of the fenestration assembly;
an exterior portion, wherein the exterior portion is adjacent an exterior side of the fenestration assembly;
a middle portion, wherein the middle portion interconnects the exterior portion and the interior portion; and
a first composition, the first composition comprising
at least 5 wt. % fibers; and
a first polymer resin;
a second composition, the second composition comprising a second polymer resin;
wherein the second composition is different than the first composition; and
wherein at least one of the interior portion, the middle portion, and the exterior portion comprises greater than 50% by volume of the first composition and another of the interior portion, the middle portion, and the exterior portion comprises greater than 50% by volume of the second composition.

54. The fenestration assembly of claim 53, wherein at least two of the interior portion, the middle portion, and the exterior portion comprises greater than 50% by volume of the first composition and the remaining one of the interior portion, the middle portion, and the exterior portion comprises greater than 50% by volume of the second composition.

55. The fenestration assembly of claim 53, wherein one of the interior portion, the middle portion, and the exterior portion comprises greater than 50% by volume of the first composition and the remaining two of the interior portion, the middle portion, and the exterior portion comprises greater than 50% by volume of the second composition.

56. The fenestration assembly of claim 53, wherein the interior portion, the middle portion, and the exterior portion each comprise at least 5% of the total interior to exterior thickness of the lineal extrusion.

57. (canceled)

58. The fenestration assembly of claim 53, wherein the at least 5 wt. % fibers are glass fibers.

59-66. (canceled)

67. The fenestration assembly of claim 53, wherein the lineal extrusion is at least 30 inches in length.

68. The fenestration assembly of claim 53, wherein the lineal extrusion at a length of 30 inches exhibits thermal bow of less than 0.06 inches upon thermal cycling with a peak to trough temperature change of at least 180 degrees fahrenheit.

69-135. (canceled)

136. A fenestration assembly comprising:
a lineal extrusion, wherein the lineal extrusion defines one or more interior hollows, the lineal extrusion comprising
a single-wall glass lip;
wherein the single-wall glass lip is adjacent an exterior side of the fenestration assembly;
wherein the single-wall glass lip at least partially defines a receiving channel for an insulating glazing unit;
a first composition, the first composition comprising
at least 5 wt. % fibers; and
a first polymer resin; and
wherein the single-wall glass lip comprises greater than 50% by volume of the first composition.

137. The fenestration assembly of claim 136, wherein the at least 5 wt. % fibers are glass fibers.

138. The fenestration assembly of claim 136, the first composition further comprising at least 10 wt. % glass fibers.

139-140. (canceled)

141. The fenestration assembly of claim 136, the lineal extrusion further comprising a second composition, wherein the second composition is different than the first composition.

142-148. (canceled)

149. The fenestration assembly of claim 136, wherein the single-wall glass lip is thicker than adjoining wall portions of the lineal extrusion.

150. The fenestration assembly of claim 136, wherein the single-wall glass lip includes a tapered portion such that a base of the single-wall glass lip is thicker than a tip of the single-wall glass lip.

151. The fenestration assembly of claim 136, wherein a wall defining an exterior wall of the lineal extrusion is thicker than other wall portions of the lineal extrusion.

152. The fenestration assembly of claim 136, wherein a base the single-wall glass lip intersects with another wall portion of the lineal extrusion forming a joint, wherein the joint is thicker than other intersections between other wall members of the lineal extrusion.

153. The fenestration assembly of claim 136, wherein a base the single-wall glass lip intersects with another wall portion of the lineal extrusion forming a joint, wherein a surface feature is disposed over an exterior side of the joint.

154-156. (canceled)
